(19) United States
(12) Patent Application Publication
(10) Pub. No.: US 2024/0388767 A1
(43) Pub. Date: Nov. 21, 2024

(54) INFORMATION PROCESSING METHOD, TERMINAL, AND SERVER

(71) Applicant: LY CORPORATION, Tokyo (JP)

(72) Inventors: Kazuya HORIUCHI, Tokyo (JP); Toshinori SATO, Tokyo (JP)

(73) Assignee: LY CORPORATION, Tokyo (JP)

(21) Appl. No.: 18/667,478

(22) Filed: May 17, 2024

Related U.S. Application Data
(63) Continuation of application No. PCT/JP2021/047414, filed on Dec. 21, 2021.

(30) Foreign Application Priority Data
Nov. 19, 2021 (JP) 2021-188959

(51) Int. Cl. H04N 21/472

(52) U.S. Cl. CPC H04N 21/47217

(57) ABSTRACT

An information processing method of a terminal configured to display a video distributed from a server, the method including: receiving, by a communication section of the terminal, the video distributed from the server; displaying on a display section of the terminal the video that is distributed; acquiring, by a control section of the terminal, first information based on a first input performed by a user of the terminal on the display section displaying the video; acquiring, by the control section, second information related to the video based on the first information; displaying the second information on the display section; and performing, by the control section, a control of playing on the display section a part corresponding to the first input in the video, based on an input for the second information performed by the user of the terminal.

### CROSS-REFERENCE TO RELATED APPLICATION

This application is a continuation of PCT International Application No. PCT/JP2021/047414 which has an International filing date of Dec. 21, 2021, the entire contents of each of which are incorporated herein by reference.

### TECHNICAL FIELD

The present disclosure relates to an information processing method, a terminal and a server.

### BACKGROUND ART

In the related art, services that distribute videos from a server have been practically used. In addition, services that transmit gift information such as social tipping to the distributed video have also been proposed (see, for example, PTL 1).

### CITATION LIST

### Patent Literature

PTL 1

Japanese Patent Application Laid-Open No. 2001-344530

### SUMMARY OF INVENTION

According to a first aspect of the present invention, an information processing method of a server is configured to communicate with a terminal configured to display a distributed video, the method including, by the server: receiving, by a communication section, first information from the terminal by distributing the video to the terminal, the first information being information based on a first input performed by a user of the terminal on a display section of the terminal displaying the video; and transmitting, by the communication section, second information related to the video to the terminal, based on the first information. The second information includes information of playing on the display section a part corresponding to the first input in the video, based on an input performed by the user of the terminal for the second information displayed on the display section.

According to a second aspect of the present invention, a terminal is configured to display a video distributed from a server, the terminal including: a communication section configured to receive the video distributed from the server; a display section configured to display the video that is distributed; and a control section configured to display second information on the display section by acquiring first information based on a first input performed by a user of the terminal on the display section displaying the video, and then acquiring the second information related to the video based on the first information. The control section performs a control of playing on the display section a part corresponding to the first input in the video, based on an input for the second information performed by the user of the terminal.

According to a third aspect of the present invention, a server is configured to communicate with a terminal configured to display a distributed video, the server including: a communication section configured to distribute the video to the terminal, and receive first information from the terminal, the first information being information based on a first input performed by a user of the terminal on a display section of the terminal displaying the video; and a control section configured to perform a control of transmitting, by the communication section, second information related to the video to the terminal, based on the first information. The second information includes information of playing on the display section a part corresponding to the first input in the video, based on an input performed by the user of the terminal for the second information displayed on the display section.

### BRIEF DESCRIPTION OF DRAWINGS

FIG. 1 is a diagram illustrating an example of a system configuration according to an aspect of an embodiment;

FIG. 2 is a diagram illustrating an example of a function that is implemented by a communication section of a terminal according to a first embodiment;

FIG. 3 is a diagram illustrating an example of a function that is implemented by a control section of the terminal according to the first embodiment;

FIG. 4 is a diagram illustrating an example of information stored in a storage section of the terminal according to the first embodiment;

FIG. 5 is a diagram illustrating an example of a function that is implemented by a communication section of a server according to the first embodiment;

FIG. 6 is a diagram illustrating an example of a function that is implemented by a control section of the server according to the first embodiment;

FIG. 7 is a diagram illustrating an example of information stored in a storage section of the server according to the first embodiment;

FIG. 8 is a flowchart illustrating an example of a procedure of processes executed by each apparatus according to the first embodiment;

FIG. 9 is a diagram illustrating an example of a time stamp displayed on a terminal in response to gifting;

FIG. 10 is a diagram illustrating an example of a state of playing a video by an input operation for a time stamp;

FIG. 11 is a diagram illustrating an example of a change in the amount of comment with respect to the distribution period of a video that is calculated in a first modification (1);

FIG. 12 is a diagram illustrating an example of a time stamp displayed on a terminal in the first modification (1);

FIG. 13 is a diagram illustrating an example of a time stamp displayed on a terminal in a first modification (2);

FIG. 14 is a diagram illustrating an example of reaction data displayed on a terminal in a first modification (3);

FIG. 15 is a diagram illustrating an example of a function that is implemented by a control section of a terminal according to a first modification (4);

FIG. 16 is a flowchart illustrating an example of a procedure of processes executed by each apparatus according to the first modification (4);

FIG. 17 is a flowchart illustrating an example of a procedure of processes executed by each apparatus according to a second embodiment;

FIG. 18 is a diagram illustrating an example of a time stamp of another user displayed on a terminal;

FIG. 19 is a flowchart illustrating an example of a procedure of processes executed by each apparatus according to a third embodiment;

FIG. 20 is a diagram illustrating an example of a state of creating a playlist in the third embodiment;

FIG. 21 is a flowchart illustrating an example of a procedure of processes executed by each apparatus according to a fourth embodiment;

FIG. 22 is a diagram illustrating an example of play location information displayed on a terminal in the fourth embodiment;

FIG. 23 is a diagram illustrating an example of a state of playing a video by an input operation for play location information;

FIG. 24 is a flowchart illustrating an example of a procedure of processes executed by each apparatus according to a fourth modification (1);

FIG. 25 is a flowchart illustrating an example of a procedure of processes executed by each apparatus according to a fifth embodiment;

FIG. 26 is a diagram illustrating an example of reaction data of a user to a video;

FIG. 27 is a diagram illustrating an example of a state where a digest video is played;

FIG. 28 is a flowchart illustrating an example of a procedure of processes executed by each apparatus according to a fifth modification (3);

FIG. 29 is a diagram illustrating an example of reaction data of a user to a video in a fifth modification (4);

FIG. 30 is a flowchart illustrating an example of a procedure of processes executed by each apparatus according to a sixth embodiment;

FIG. 31 is a diagram illustrating an example of a state of creating a playlist in the sixth embodiment;

FIG. 32 is a diagram illustrating an example of a state where original video A is played in a seventh embodiment;

FIG. 33 is a diagram illustrating an example of a state where original video B is played in the seventh embodiment;

FIG. 34 is a diagram illustrating an example of a state of playing an original video of a playlist in the seventh modification (1);

FIG. 35 is a diagram illustrating an example of content information displayed on a terminal in a ninth embodiment;

FIG. 36 is a diagram illustrating an example of a state where gifting of a gift to a video is performed in a tenth embodiment;

FIG. 37 is a diagram illustrating an example of a state where another user's gift is removed from a digest video in a tenth embodiment;

FIG. 38 is a diagram illustrating an example of content information of a gift displayed on a terminal in an eleventh embodiment;

FIG. 39 is a flowchart illustrating an example of a procedure of processes executed by each apparatus according to a twelfth embodiment; and

FIG. 40 is a diagram illustrating an example of a state where content is transmitted from a distributor's terminal to a viewer's terminal.

### DESCRIPTION OF EMBODIMENTS

Compliance with Legal Matters

It should be noted that the disclosures contained herein are subject to compliance with the legal requirements of the country required for implementation of the disclosure, including the confidentiality of communications.

Embodiments of the server, program and information processing method according to the present disclosure are described below with reference to the accompanying drawings.

### System Configuration

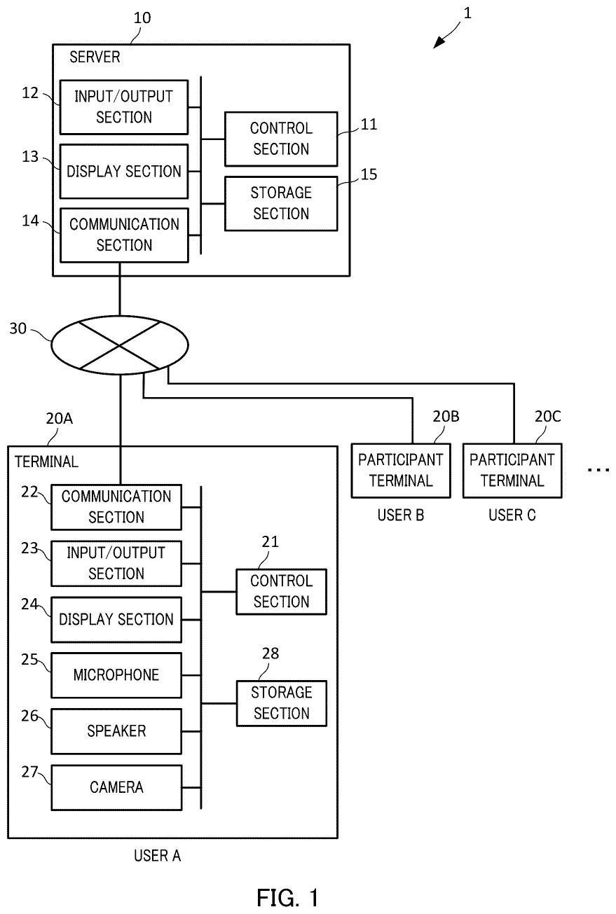

FIG. 1 is a diagram illustrating a configuration of system 1 including a server according to an embodiment of the present disclosure. As illustrated in FIG. 1, in system 1, server 10 and terminal 20 (terminal 20A, terminal 20B, terminal 20C . . . ) are connected through network 30.

Server 10 has a function of communicating with terminal 20 through network 30. Note that the number of terminals 20 connected to server 10 is not limited.

Network 30 serves a role of connecting one or more servers 10 and one or more terminals 20. Specifically, network 30 means a communication network that provides a connection path such that data can be transmitted and received among the above-mentioned various apparatuses.

One or a plurality of parts in network 30 may or may not be a wired network or a wireless network. Network 30 may include, by way of example but not limitation, adhoc network, intranet, extranet, virtual private network (VPN), local area network (LAN), wireless LAN (WLAN), wide area network (WAN), wireless WAN (WWAN), metropolitan area network (MAN), a part of the Internet, a part of public switched telephone network (PSTN), cellular telephone network, integrated service digital network (ISDN), wireless LAN, long term evolution (LTE), code division multiple access (CDMA), Bluetooth (registered trademark), satellite communication, or combinations of two or more of them. Network 30 may include one or a plurality of networks 30.

Terminal 20 is a terminal that is used by users who mutually exchange contents. This terminal 20 is not limited as long as it is an information processing terminal that can achieve functions described in each embodiment. Terminal 20 includes, by way of example but not limitation, a smartphone, a mobile phone (feature phone), a computer (such as, by way of example but not limitation, a desk top, a laptop, and a tablet), a media computer platform (such as, by way of example but not limitation, a cable, a satellite set top box, and a digital video recorder), a hand-held computer device (such as, by way of example but not limitation, a PDA (personal digital assistant), and an electronic mail client), a wearable terminal (such as an eyeglasses-type device and a clock-type device), computers of other types, and communication platforms. In addition, terminal 20 may be referred to as information processing terminal.

In addition, as necessary, user information in predetermined service associated with terminal 20 is referred to as user information X. Note that the user information is information about the user associated with the account used by the user in predetermined service. The user information may include, by way of example but not limitation, information associated with the user input by the user or given by predetermined service, such as a list of the user's name, the user's icon image, the user's age, the user's gender, the user's address, the user's hobby, the user's identifier, and the user's friend or acquaintance. The user information may or may not be one of them, or a combination of them.

### Hardware (HW) Configuration of Each Apparatus

An HW configuration of each apparatus included in system 1 is described below.

### (1) HW Configuration of Terminal

FIG. 1 illustrates an example of an HW configuration of terminal 20. Terminal 20 includes control section 21 (CPU: central processing unit), storage section 28, communication section 22, input/output section 23, display section 24, microphone 25, speaker 26, and camera 27. The components of the HW of terminal 20 are, by way of example but not limitation, connected to each other through a bus. Note that the HW configuration of terminal 20 need not necessarily include all components. By way of example but not limitation, terminal 20 may or may not be configured such that individual components or a plurality of components such as microphone 25 and camera 27 are detachable.

Communication section 22 transmits and receives various data through network 30. Communication may be carried out in a wired or wireless manner, and any communication protocol may be used as long as mutual communication can be executed. Communication section 22 has a function of communicating with various apparatuses such as server 10 through network 30. Communication section 22 transmits various data to various apparatuses such as server 10 under the instruction of control section 21. In addition, communication section 22 receives various data sent from various apparatuses such as server 10 and transmits it to control section 21. In addition, in the case where communication section 22 is composed of a physically structured circuit, it may be referred to as communication circuit.

Input/output section 23 includes an apparatus for inputting various operations for terminal 20, and an apparatus for outputting the processing result processed by terminal 20. Input/output section 23 may include the input section and the output section integrated with each other, or input/output section 23 may or may not be separated into the input section and the output section.

The input section is achieved with all types of apparatuses or a combination of them that can receive an input from the user and transmit information about the input to control section 21. The input section includes, by way of example but not limitation, a hardware key such as a touch panel, a touch display and a keyboard, a pointing device such as a mouse, a camera (an operation input via a video), and a microphone (an operation input using a voice).

The output section is achieved with all types of apparatuses or a combination of them that can output the processing result processed by control section 21. The output section includes, by way of example but not limitation, a touch panel, a touch display, a speaker (voice output), a lens (such as, by way of example but not limitation, a 3D (three dimensions) and a hologram output), and a printer.

Display section 24 is achieved with all types of apparatuses or a combination of them that can perform a display in accordance with display data written to a frame buffer. Display section 24 includes, by way of example but not limitation, a touch panel, a touch display, a monitor (such as, by way of example but not limitation, a liquid crystal display and an OELD (organic electroluminescence display)), a head-mounted display (HDM), a projection mapping, a hologram, and an apparatus capable of displaying images, text information, and the like in air or the like (which may or may not be a vacuum).

In the case where input/output section 23 is a touch panel, input/output section 23 and display section 24 may be disposed to face each other with substantially the same size and shape.

Control section 21 includes a physically structured circuit configured to execute a function that is implemented by a command or code included in a program, and control section 21 is achieved by, by way of example but not limitation, a data processing device incorporated in hardware. Therefore, control section 21 may or may not be referred to as control circuit.

Control section 21 includes, by way of example but not limitation, a center processing device (CPU), a microprocessor, a processor core, a multiple processor, an ASIC (application-specific integrated circuit), and an FPGA (field programmable gate array).

Storage section 28 has a function of storing various programs and various data required for operating terminal 20. Storage section 28 includes, by way of example but not limitation, various storage mediums such as an HDD (hard disk drive), an SSD (solid state drive), a flash memory, a RAM (random access memory), and a ROM (read only memory). In addition, storage section 28 may or may not be referred to as memory.

Terminal 20 stores a program in storage section 28 and executes this program, and thus control section 21 executes processes as each section included in control section 21. That is, the programs stored in storage section 28 cause terminal 20 to implement each function executed by control section 21. In addition, this program may or may not be referred to as program module.

Microphone 25 is used for input of voice data. Speaker 26 is used for output of voice data. Camera 27 is used for acquisition of moving image data.

### (2) HW Configuration of Server

FIG. 1 illustrates an example of a HW configuration of server 10. Server 10 includes, by way of example but not limitation, control section 11 (CPU), storage section 15, communication section 14, input/output section 12, and display 13. The components of the HW of server 10 are, by way of example but not limitation, connected to each other through a bus. Note that the HW of server 10 need not necessarily include all components. By way of example but not limitation, the HW of server 10 may or may not be configured such that display 13 is detachable.

Control section 11 includes a physically structured circuit configured to execute a function that is implemented by a command or code included in a program, and control section 11 is achieved by, by way of example but not limitation, a data processing device incorporated in hardware.

Control section 11 is typically a center processing device (CPU), and may or may not be a microprocessor, a processor core, a multiple processor, an ASIC, or an FPGA. In the present disclosure, control section 11 is not limited to this.

Storage section 15 has a function of storing various programs and various data required for operating server 10. Storage section 15 is achieved by various storage mediums such as an HDD, an SSD, and a flash memory. It should be noted that in the present disclosure, storage section 15 is not limited to this. In addition, storage section 15 may or may not be referred to as memory.

Communication section 14 transmits and receives various data through network 30. Communication may be carried out in a wired or wireless manner, and any communication protocol may be used as long as mutual communication can be executed. Communication section 14 has a function of communicating with various apparatuses such as terminal 20 through network 30. Communication section 14 transmits various data to various apparatuses such as terminal 20 under the instruction of control section 11. In addition, communication section 14 receives various data sent from various apparatuses such as terminal 20, and transmits it to control section 11. In addition, in the case where communication section 14 is composed of a physically structured circuit, it may be referred to as communication circuit.

Input/output section 12 is achieved by an apparatus for inputting various operation for server 10. Input/output section 12 is achieved with all types of apparatuses or a combination of them that can receive an input from the user and transmit information about the input to control section 11. Input/output section 12 is typically achieved by a hardware key typified by a keyboard, or a pointing device such as a mouse. Note that input/output section 12 may or may not include, by way of example but not limitation, a touch panel, a camera (an operation input via a video), a microphone (an operation input using a voice). It should be noted that in the present disclosure, input/output section 12 is not limited to this.

Display 13 is typically achieved by a monitor (such as, by way of example but not limitation, a liquid crystal display and an OELD (organic electroluminescence display)). Note that display 13 may or may not be a head-mounted display (HDM). Note that these displays 13 may or may not be able to display the display data in a 3D manner. In the present disclosure, display 13 is not limited to this.

### (3) Other Configurations

Server 10 stores a program in storage section 15 and executes this program, and thus control section 11 executes a process as each section included in control section 11. That is, the program stored in storage section 15 causes server 10 to achieve each function executed by control section 11. This program may or may not be referred to as program module.

Each embodiment of the present disclosure is assumed to be implemented when the CPU of server 10 and/or terminal 20 executes the program.

Note that control section 11 of server 10 and/or control section 21 of terminal 20 may or may not achieve each process not only by the CPU including the control circuit, but also by a dedicated circuit or a logic circuit (hardware) formed on an integrated circuit (IC) chip or an LSI (Large Scale Integration)). In addition, these circuits may be achieved by one or a plurality of integrated circuits, and a plurality of processes described in each embodiment may or may not be achieved with one integrated circuit. In addition, the LSI may be referred to as VLSI, super LSI, ultra LSI or the like depending on the difference in integration density. Therefore, control sections 11 and 21 may or may not be referred to as control circuit.

In addition, the program (such as, by way of example but not limitation, a software program, a computer program, or a program module) of each embodiment of the present disclosure may or may not be provided in a state where it is stored in a computer-readable storage medium. The storage medium may store programs in a “non-transitory tangible medium”. In addition, the program may or may not be configured to achieve a part of the function of each embodiment of the present disclosure. Further, it may or may not be a so-called difference file (difference program) that can achieve the functions of each embodiment of the present disclosure by a combination with programs preliminarily recorded in the storage medium.

Storage medium may include one or more semiconductor based, or other integrated circuits (IC) (such as, by way of example but not limitation, a field programmable gate array (FPGA) and an application-specific IC (ASIC)), a hard disk drive (HDD), a hybrid hard drive (HHD), an optical disk, an optical disk drive (ODD), a magneto-optical disc, a magneto-optical drive, a floppy diskette, a floppy disk drive (FDD), a magnetism tape, a solid drive (SSD), a RAM drive, a secure digital card or drive, any other appropriate storage mediums, and combinations of one or more of them. Storage medium may appropriately be a volatile storage medium, a nonvolatile storage medium, or a combination of a volatile storage medium and a nonvolatile storage medium. Note that the storage medium is not limited to these examples, and any device or medium may be used as long as the program can be stored. In addition, the storage medium may or may not be referred to as memory.

Server 10 and/or terminal 20 can achieve functions of a plurality of functional parts described in each embodiment by reading programs stored in the storage medium and executing the read programs.

In addition, the program of the present disclosure may or may not be provided to server 10 and/or terminal 20 through a given transmission medium (such as communication networks and broadcast waves) that can transmit programs. By way of example but not limitation, server 10 and/or terminal 20 achieves the functions of a plurality of functional parts described in each embodiment by executing a program downloaded through the Internet or the like.

In addition, each embodiment of the present disclosure may be achieved in the form of data signals embedded in carrier waves in which programs are embodied by electronic transmission. At least some of processes in server 10 and/or terminal 20 may or may not be achieved by cloud computing composed of one or more computers. At least some of the processes in terminal 20 may or may not be performed by server 10. In this case, at least some of processes of each functional part of control section 21 of terminal 20 may or may not be configured to be performed by server 10. At least some of the processes in server 10 may or may not be configured to be performed by terminal 20. In this case, at least some of processes of each functional part of control section 11 of server 10 may or may not be configured to be performed by terminal 20. Unless otherwise noted, the configuration of the determination in the embodiment of the present disclosure is not essential, and a predetermined process may or may not be performed when a determination condition is satisfied, or, a predetermined process may or may not be performed when a determination condition is not satisfied.

Note that by way of example but not limitation, the program of the present disclosure is implemented using scripting languages such as ActionScript and JavaScript (registered trademark), object-oriented programming languages such as Objective-C and Java (registered trademark), markup languages such as HTML5, and the like.

In addition, as described above, various programs and various data in the present disclosure can be stored (recorded) in a computer-readable storage medium (recording medium). This storage medium includes various storage mediums such as a magnetic disc, an optical disk, a magneto-optical disc, and a flash memory.

### First Embodiment

In the first embodiment, when user B performs gifting to a video distributed from server 10, a time stamp is displayed and the part where the gifting of the gift is performed is played. The details of the first embodiment are applicable to any of other embodiments.

### Functional Configuration

### (1) Functional Configuration of Terminal

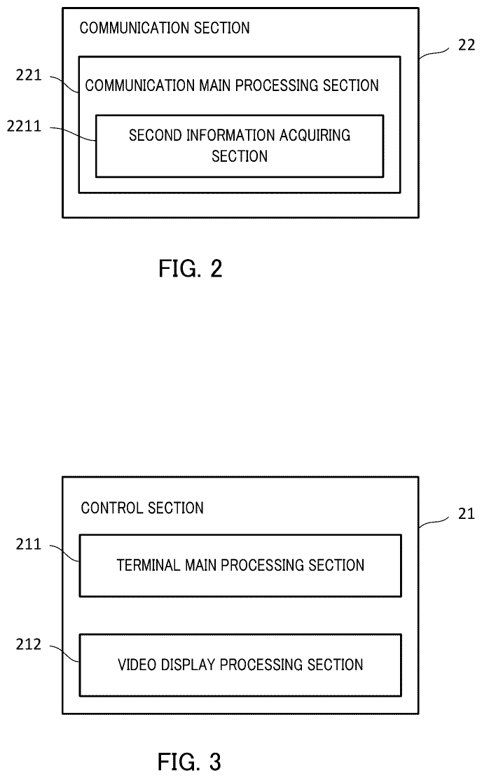

FIG. 2 is a diagram illustrating an example of a function that is implemented by communication section 22 of terminal 20 in the present embodiment. Communication section 22 includes, by way of example but not limitation, communication main processing section 221.

Communication main processing section 221 has a function of executing a communication main process of transmitting to and receiving from server 10 the content under the control of control section 21. For example, communication main processing section 221 has a function of receiving the video distributed from server 10. In addition, communication main processing section 221 has a function of transmitting to server 10 gift information (which is, by way of example but not limitation, an example of the first information) on the basis of the first input of the user performed on display section 24 displaying a video. Note that the gift information is information about the gift that is sent from the user to the distributor by the first input, and may include details of the gift, the time when the gifting of the gift is performed (e.g., a time with respect to the total distribution period of the video) and the like, for example. Here, the gift may include social tipping, gift items, comments and the like. For example, the social tipping may include proprietary currency (such as currency used in the video distribution community) purchased from the operator of the video distribution or the like. In addition, the social tipping may include direct remittance from the user to the distributor, such as remittance by means of electronic payment (such as access-type payment and stored-value payment), provision of points (such as redeemable points and scores), provision of electronic money certificates (such as electronic gift certificates and electronic goods certificates), and provision of virtual currency. In addition, the gift item may include virtual items, stamps, and other image items and video items purchased from the operator of the video distribution or the like, for example. In addition, the comment may include messages and the like to the distributor, for example. Here, communication main processing section 221 includes second information acquiring section 2211.

Under the control of control section 21, second information acquiring section 2211 executes a second information acquisition process of receiving from server 10 a time stamp (which is, by way of example but not limitation, an example of the second information) of a video generated based on the gift information.

FIG. 3 is a diagram illustrating an example of a function that is implemented by control section 21 of terminal 20 in the present embodiment. Control section 21 includes, by way of example but not limitation, terminal main processing section 211 and video display processing section 212.

Terminal main processing section 211 has a function of executing a terminal main process of generally controlling terminal 20 in accordance with terminal main processing program 281 stored in storage section 28. For example, terminal main processing section 211 performs a control of transmitting to server 10 gift information of the user for a video.

Video display processing section 212 executes a video display process of displaying a video on display section 24 in accordance with video display processing program 2811 stored in storage section 28. For example, video display processing section 212 performs a control of displaying the video distributed from server 10 on display section 24. In addition, video display processing section 212 performs a control of playing a part corresponding to the first input of the user in the video distributed from server 10.

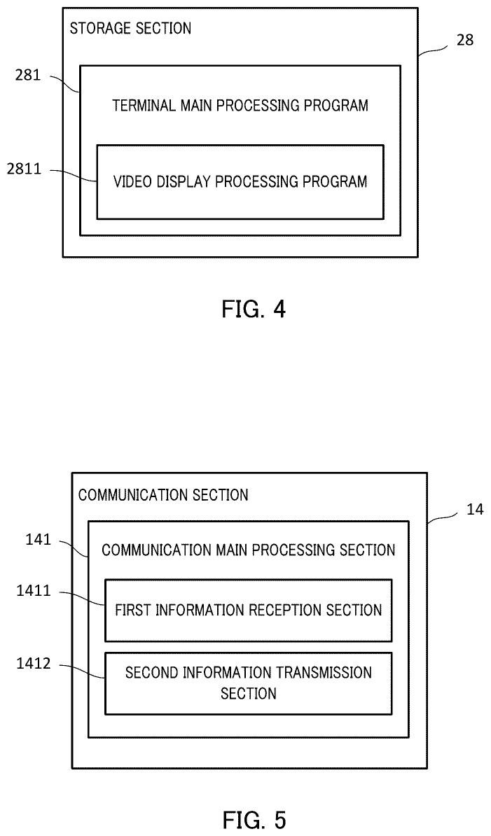

FIG. 4 is a diagram illustrating an example of information stored in storage section 28 of terminal 20 in the present embodiment. Storage section 28 stores, by way of example but not limitation, terminal main processing program 281 that is read by control section 21 and executed as a terminal main process. In addition, terminal main processing program 281 includes, by way of example but not limitation, video display processing program 2811 that is read by control section 21 and executed as a video display process as a sub routine program.

### (2) Functional Configuration of Server

FIG. 5 is a diagram illustrating an example of a function that is implemented by communication section 14 of server 10 in the present embodiment. Communication section 14 includes, by way of example but not limitation, communication main processing section 141.

Communication main processing section 141 has a function of executing a communication main process of communicating with terminal 20 that displays distributed videos under the control of control section 11. For example, communication main processing section 141 has a function of distributing a video to terminal 20. Here, communication main processing section 141 includes first information reception section 1411, and second information transmission section 1412.

First information reception section 1411 has a function of receiving from terminal 20 the gift information on the basis of the first input of the user performed on display section 24 of terminal 20 displaying a video under the control of control section 11. Second information transmission section 1412 has a function of transmitting to terminal 20 a time stamp related to the video on the basis of the gift information under the control of control section 11.

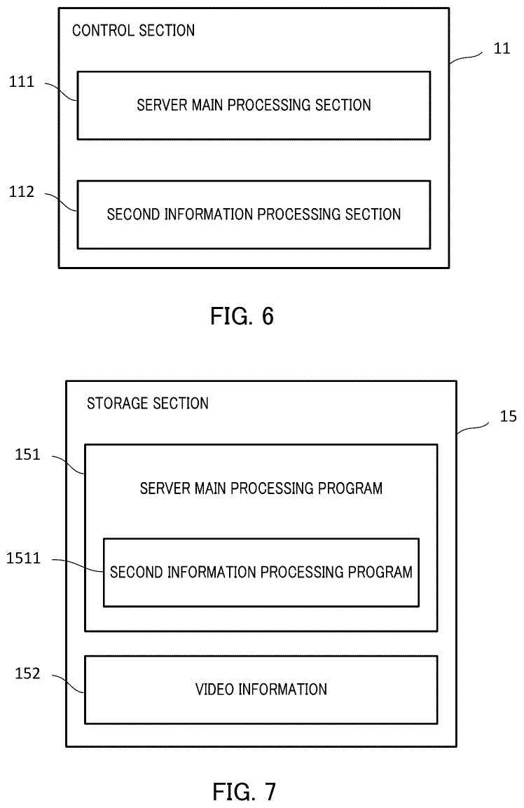

FIG. 6 is a diagram illustrating an example of a function that is implemented by control section 11 of server 10 in the present embodiment. Control section 11 includes, by way of example but not limitation, server main processing section 111, and second information processing section 112.

Server main processing section 111 has a function of executing a server main process that is a process for generally controlling server 10 in accordance with server main processing program 151 stored in storage section 15. For example, server main processing section 111 performs a control of distributing a video to terminal 20. In addition, server main processing section 111 performs a control of transmitting to terminal 20 a time stamp generated by second information processing section 112.

Second information processing section 112 executes a second information process of generating a time stamp of a video corresponding to the first input of the user in accordance with second information processing program 1511 stored in storage section 15.

FIG. 7 is a diagram illustrating an example of information stored in storage section 15 of server 10 in the present embodiment. Storage section 15 stores, by way of example but not limitation, server main processing program 151 that is read by control section 11 and executed as a server main process. In addition, server main processing program 151 includes, by way of example but not limitation, second information processing program 1511 that is read by control section 11 and executed as a second information process as a sub routine program.

In addition, storage section 15 stores, by way of example but not limitation, video information 152 that includes data of a video that is distributed to the terminal.

### Information Processing

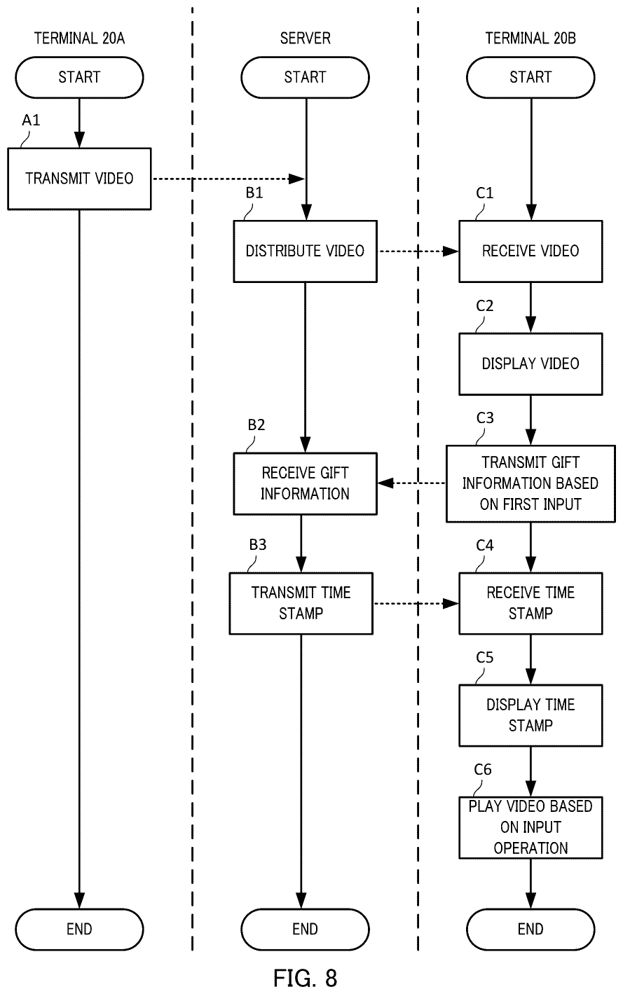

FIG. 8 is a flowchart illustrating an example of a procedure of processes executed by each apparatus in the present embodiment. From left, examples of a process executed by control section 21 of terminal 20A, a process executed by control section 11 of server 10, and a process executed by control section 21 of terminal 20B are illustrated. For example, terminal 20A may make up the distributor's terminal of the present disclosure, and terminal 20B may make up the viewer's terminal of a distributed video of the present disclosure.

Each step in each process is indicated by a combination of capital letters and numbers, and the term “step” is omitted in this specification. The flowchart described below is only an example of the process in this example, and some steps may not be executed or additional steps may be inserted in the flowchart described below. The same applies to other flowcharts in this specification.

First, control section 21 of terminal 20A transmits to server 10 a video to be distributed to other terminal 20B by communication section 22 in accordance with an operation of user A who is a distributor (A1). Note that the video may be a real-time video, a recorded video, or a combination of them, for example. When receiving a video from terminal 20A, control section 11 of server 10 distributes the video to terminal 20B while storing the video in storage section 15 (B1).

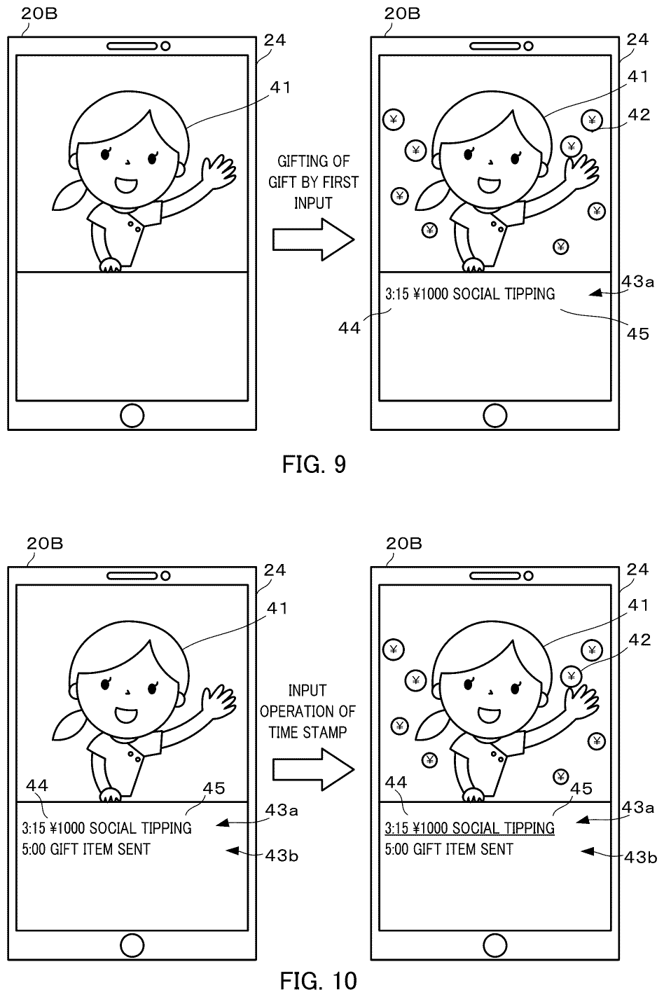

The video distributed from server 10 is received by communication section 22 of terminal 20B (C1). Then, as illustrated in FIG. 9, control section 21 of terminal 20B causes display section 24 to display the video distributed from server 10 while storing the video in storage section 28 (C2). In this manner, the video displayed on display section 24 is viewed by user B. Here, it is assumed that user B has performed a first input for gifting of gift 42 on display section 24 displaying video 41 while viewing video 41. Note that the first input on display section 24 displaying video 41 means an input for a certain scene in video 41, not an input of directly touching display section 24.

In addition, gifting of gift 42 is performed from the user B viewing video 41 to the distributor to show support for or to thank the distributor of video 41, and gift 42 may include social tipping, gift items, comments and the like, for example. Social tipping and gift items can be obtained through charging, and effects corresponding to the type, the charging amount and the like are displayed on display section 24 together with video 41, for example. Note that the social tipping may be obtained in advance through charging, and sent from user B to the distributor in accordance with the first input, for example. In addition, when user B obtains social tipping, the amount corresponding to the value of the social tipping may be paid by the payment service (e.g., a credit card or the like) registered by user B. Then, the amount corresponding to the value (e.g., the charging amount) of the social tipping sent from user B may be paid from the operator to the distributor. On the other hand, various items corresponding to the charging amount may be provided by the operator as the gift item. User B obtains the desired gift item through charging, and the gift item is sent from user B to the distributor in accordance with the first input. In addition, when user B obtains a gift item, the amount corresponding to the value of the gift item may be paid by a payment service (e.g., a credit card or the like) registered by user B. Then, the amount corresponding to the type of the gift item sent from user B may be paid from the operator to the distributor.

On the basis of the first input of user B, control section 21 of terminal 20B acquires the gift information about gift 42 selected by user B as first information and transmits the gift information to server 10 (C3). Here, the gift information is information about gift 42 that is sent from user B to the distributor, and may include the content of gift 42, the time when the gifting of gift 42 is performed (e.g., a time with respect to the total distribution period of video 41) and the like, for example. Note that the content of gift 42 may include identification information (e.g., the charging amount of the social tipping, the type of the gift item and the like) of gift 42, the details of the comment and the like, for example.

When the gift information sent from terminal 20B is received by communication section 14 (B2), control section 11 of server 10 displays in a superimposed manner gift 42 on video 41 distributed to terminal 20B on the basis of the gift information as illustrated in FIG. 9. In this manner, user B can confirm gift 42 sent by user B, and view the subsequent reactions of the distributor to gift 42. In addition, control section 11 of server 10 generates a time stamp for playing the part corresponding to the first input in video 41 as the second information related to video 41 on the basis of the gift information. Control section 11 of server 10 transmits the generated time stamp to terminal 20B (B3).

The time stamp sent from server 10 is received by communication section 22 of terminal 20B (C4), and stored in storage section 28 of terminal 20B. In this manner, control section 21 of terminal 20B acquires a time stamp representing the play position corresponding to the first input of the gifting of gift 42 on the basis of the gift information. As illustrated in FIG. 9, control section 21 of terminal 20B displays acquired time stamp 43a on display section 24 (C5). Time stamp 43a may include time information 44 representing the time “3:15” of the play position corresponding to the first input, control information for moving the screen of video 41 to that play position, and content information 45 of “1,000 yen social tipping” representing the content of gift 42, for example. Note that time information 44 needs only to represent the play position corresponding to the first input time, and may be set to a time shifted backward or forward by a predetermined time with respect to the first input time, for example.

Here, as illustrated in FIG. 10, it is assumed that user B performs the first input two times on video 41, and that two time stamps 43a and 43b are displayed on display section 24. Further, when user B desires to view the scene where gifting of gift 42 is performed in video 41 again, user B performs input operation of time stamps 43a and 43b.

For example, when user B has performed the input operation of time stamp 43a, control section 21 of terminal 20B transfers the screen of display section 24 to the scene corresponding to the first input of time stamp 43a (the scene corresponding to the time “3:15”) in video 41 on the basis of the control information of time stamp 43a. Further, control section 21 of terminal 20B controls display section 24 to play video 41 from the transferred scene (C6). In this manner, display section 24 plays the scene where user B has performed “1,000 yen social tipping” in video 41.

Here, control section 11 of server 10 distributes the video to terminal 20B while storing the video in storage section 15. In addition, control section 21 of terminal 20B displays the video distributed from server 10 on display section 24 while storing the video in storage section 28. In this manner, even in the case where the input operation of time stamp 43a has performed during distribution of video 41, control section 21 of terminal 20B can transition to the scene corresponding to the first input of time stamp 43a to play video 41, for example.

Note that control section 21 of terminal 20B may or may not display a button for returning video 41 to be played on display section 24 from the scene corresponding to the first input to the scene that is being distributed. At this time, when video 41 is being distributed live, control section 21 of terminal 20B may control display section 24 to return from the scene corresponding to the first input of time stamp 43a to the live image of video 41 that is being currently distributed in response to the operation of the return button. In addition, when recorded video 41 is being distributed, control section 21 of terminal 20B may control display section 24 to return to the scene of video 41 that has been viewed before the input operation of time stamp 43a in response to the operation of the return button. For example, it is assumed that at the time when video 41 being distributed is viewed up to the scene of the time “6:00”, user B performs the input operation of time stamp 43a, and then returns video 41 to the scene of the time “3:15” and views video 41. Then, when the input operation of the return button is performed at the time when video 41 has been viewed from the scene of the time “3:15” to the time “4:00”, control section 21 of terminal 20B may control display section 24 to return to the scene of the time “6:00” that has been viewed before the input operation of time stamp 43a.

At this time, control section 21 of terminal 20B may or may not control display section 24 to display the return button near video 41 played on display section 24. In addition, control section 21 of terminal 20B may or may not control display section 24 to display the return button in a superimposed manner on video 41 being played on display section 24.

In this manner, control section 21 of terminal 20B controls display section 24 to play the part corresponding to the first input of time stamps 43a and 43b in video 41 on the basis of the input operation of time stamps 43a and 43b. Note that control section 21 of terminal 20B may play video 41 by a predetermined time set in advance from the part corresponding to the first input of time stamps 43a and 43b, or play video 41 to the end of video 41, for example. In addition, when input operation of switching from time stamp 43a to time stamp 43b is performed, control section 21 of terminal 20B transfers the scene from the scene corresponding to the first input of time stamp 43a to the scene corresponding to the first input of time stamp 43b, for example.

### Effects of First Embodiment

In the first embodiment, control section 21 of terminal 20B acquires time stamps 43a and 43b (which are, by way of example but not limitation, an example of the information representing the play position) related to video 41 on the basis of gift information (which is, by way of example but not limitation, an example of the first information), and displays time stamps 43a and 43b on display section 24. Then, control section 21 of terminal 20B displays the part corresponding to the first input in video 41 on display section 24 on the basis of the input of user B for time stamps 43a and 43b. As an example of the effect of such a configuration, user B can easily look back the scene where gifting of gift 42 is performed in video 41.

In addition, in the first embodiment, the first information may include the gift information of user B for video 41. As an example of the effect of such a configuration, control section 21 of terminal 20B can easily and correctly play the scene where gifting of gift 42 is performed in video 41.

In addition, in the first embodiment, the second information may include time stamps 43a and 43b (which are, by way of example but not limitation, an example of the information representing the play position) representing the play position corresponding to the first input in video 41. As an example of the effect of such a configuration, control section 21 of terminal 20B can more easily and correctly play the scene where gifting of gift 42 is performed in video 41.

In addition, in the first embodiment, time stamps 43a and 43b may include time information 44 related to the time (by way of example but not limitation, time information related to an example). As an example of the effect of such a configuration, control section 21 of terminal 20B can more easily and correctly play the scene where gifting of gift 42 is performed in video 41.

### First Modification (1)

In the first embodiment, time stamps 43a and 43b include time information 44 related to the time representing a certain time point, but it may include time-period information related to the time representing a certain time period. First modification (1) is a modification in which time stamps 43a and 43b include time-period information.

For example, as in the first embodiment, when the gift information sent from terminal 20B is received by communication section 14 (B2), control section 11 of server 10 generates time stamps 43a and 43b on the basis of that gift information. At this time, control section 11 of server 10 may or may not generate time stamps 43a and 43b so as to include time-period information representing the time period “3:15 to 3:30” and the time period “5:00 to 5:15” corresponding to the first input of user B.

For example, control section 11 of server 10 may or may not set the time-period information to the time period “3:15 to 3:30” and time period “5:00 to 5:15” in a predetermined range that are set in advance from the time “3:15” and the time “5:00” corresponding to the first input.

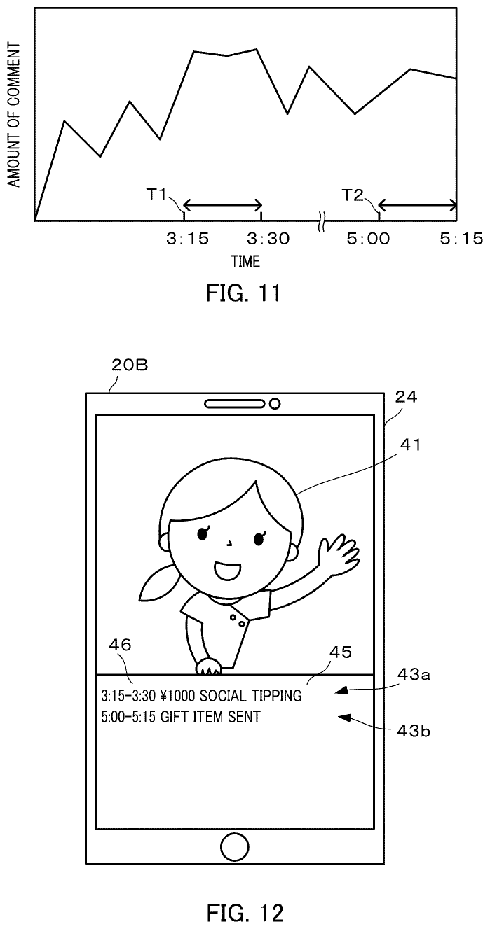

In addition, control section 11 of server 10 may or may not set the time-period information on the basis of at least one of the amount of the comment of the user for the distributor of video 41 (such as the amount of comment and the number of letters), the distributor's voice (such as the volume), and the distributor's facial expression (such as the size of the mouth or eyes, and the number of movements). For example, as illustrated in FIG. 11, control section 11 of server 10 may calculate the change in the amount of comment with respect to the distribution period on the basis of the information about video 41. Then, control section 11 of server 10 may set the time-period information to the time period “3:15 to 3:30” and the time period “5:00 to 5:15” where the amount of increase in the amount of comment from the time “3:15” and the time “5:00” of two first inputs T1 and T2 is equal to or greater than a predetermined value.

In addition, control section 11 of server 10 may detect a voice such as “user B” related to first inputs T1 and T2 by analyzing the distributor's voice on the basis of the information about video 41. For example, in the case where a voice “Thank you user B” is detected at the time “3:30” and the time “5:15” after first inputs T1 and T2, control section 11 of server 10 may set the time period “3:15 to 3:30” and the time period “5:00 to 5:15” to the time-period information.

In addition, control section 11 of server 10 may analyze the distributor's facial expression on the basis of the information about video 41. In general, when gifting of gift 42 is performed, the facial expression of the distributor's mouth, eyes, and the like significantly change such as when responding to the user who has performed the gifting of gift 42. In view of this, control section 11 of server 10 may set the time-period information to the time period “3:15 to 3:30” and the time period “5:00 to 5:15” where the size and/or the number of movements of the distributor's mouth changes by a predetermined value or more after first inputs T1 and T2, for example.

In this manner, when time stamps 43a and 43b including time-period information is generated, control section 11 of server 10 transmits the time stamps 43a and 43b to terminal 20B (B3). The time stamps 43a and 43b sent from server 10 are received by communication section 22 of terminal 20B (C4). Then, as illustrated in FIG. 12, control section 21 of terminal 20B controls display section 24 to display time stamps 43a and 43b including time-period information 46 (C5).

### Effects of First Modification (1)

In first modification (1), time stamps 43a and 43b include time-period information 46 related to the time (by way of example but not limitation, time information related to an example). As an example of the effect of such a configuration, control section 21 of terminal 20B can more easily and correctly play the scene where gifting of gift 42 is performed in video 41.

### First Modification (2)

In the first embodiment, time stamps 43a and 43b include time information 44 and the like, but this is not limitative, and it needs only to include information representing the play position corresponding to the first input. First modification (2) is a modification in which time stamps 43a and 43b include information representing the order of gift 42 in addition to or instead of the time information and/or the time-period information, as information representing the play position corresponding to the first input.

For example, as in the first embodiment, when the gift information sent from terminal 20B is received by communication section 14 (B2), control section 11 of server 10 generates time stamps 43a and 43b on the basis of that gift information. At this time, control section 11 of server 10 may or may not calculate the order of first input T1 and first input T2 performed by user B on the basis of the gift information. Then, control section 11 of server 10 may generate time stamps 43a and 43b including number information representing the order of first inputs T1 and T2.

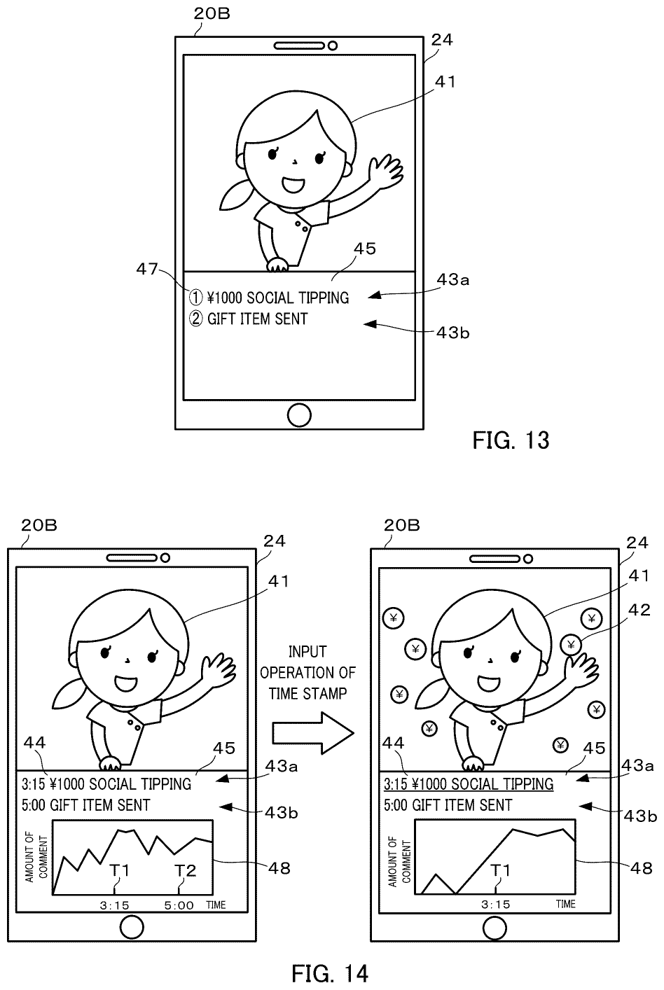

In this manner, time stamps 43a and 43b displayed on display section 24 of terminal 20B include order information 47 representing the play position corresponding to first inputs T1 and T2 as illustrated in FIG. 13.

### Effects of First Modification (2)

In first modification (2), time stamps 43a and 43b include order information 47 (which is, by way of example but not limitation, an example of the information representing the play position corresponding to first inputs T1 and T2) related to the order of first inputs T1 and T2. As an example of the effect of such a configuration, control section 21 of terminal 20B can easily and correctly play the scene where gifting of gift 42 is performed in video 41.

### First Modification (3)

In the first embodiment, the second information displayed on display section 24 of terminal 20B may include data related to the user's reaction to video 41. First modification (3) is a modification in which data representing a change in the number of user's comments for video 41 is displayed on display section 24 of terminal 20B.

For example, as in the first embodiment, when the gift information sent from terminal 20B is received by communication section 14 (B2), control section 11 of server 10 generates time stamps 43a and 43b on the basis of that gift information. At this time, as illustrated in FIG. 11, control section 11 of server 10 may or may not create reaction data representing a change in the amount of comment with respect to the distribution period on the basis of the information about video 41.

Control section 11 of server 10 transmits to terminal 20B the created reaction data together with time stamps 43a and 43b (B3). When the reaction data and time stamps 43a and 43b are received by communication section 22 (C4), control section 21 of terminal 20B controls display section 24 to display reaction data 48 together with time stamps 43a and 43b as illustrated in FIG. 14 (C5).

By way of example but not limitation, this reaction data 48 may or may not display the timing when first input T1 and first input T2 are performed by user B, i.e., the timing when gifting of gift 42 is performed by user B with respect to the distribution period of video 41. In addition, reaction data 48 may or may not display the timing when gifting of gift 42 is performed by a user other than user B.

In addition, in the case where time stamp 43a of time stamps 43a and 43b displayed on display section 24 is input by user B, control section 21 of terminal 20B displays on display section 24 the part corresponding to first input T1 of time stamp 43a in video 41. At this time, control section 21 of terminal 20B may or may not display in an enlarged manner the part corresponding to first input T1 in reaction data 48 in response to the input operation for time stamp 43a.

Note that reaction data 48 needs only to be data related to the reaction of the user viewing video 41 and/or the distributor distributing video 41, and is not limited to the data about the amount of comment. For example, reaction data 48 may be graph data of the change in the amount of gifting of gift 42 performed by user B (e.g., the change in amount of social tipping and/or gift items). In addition, reaction data 48 may or may not be data representing the change in the number of viewers with respect to the distribution period of video 41.

### Effects of First Modification (3)

In first modification (3), the second information includes reaction data 48 related to the user's reaction to video 41 (which is, by way of example but not limitation, an example of data related to the user's reaction to video 41). As an example of the effect of such a configuration, user B can easily recognize the reactions of other users to the gifting of gift 42.

### First Modification (4)

In the first embodiment, control section 21 of terminal 20B receives time stamps 43a and 43b generated by server 10, but this is not limitative as long as time stamps 43a and 43b (which are, by way of example but not limitation, an example of the second information) can be acquired. First modification (4) is a modification in which control section 21 of terminal 20B generates time stamps 43a and 43b.

### Functional Configuration

### (1) Functional Configuration of Terminal

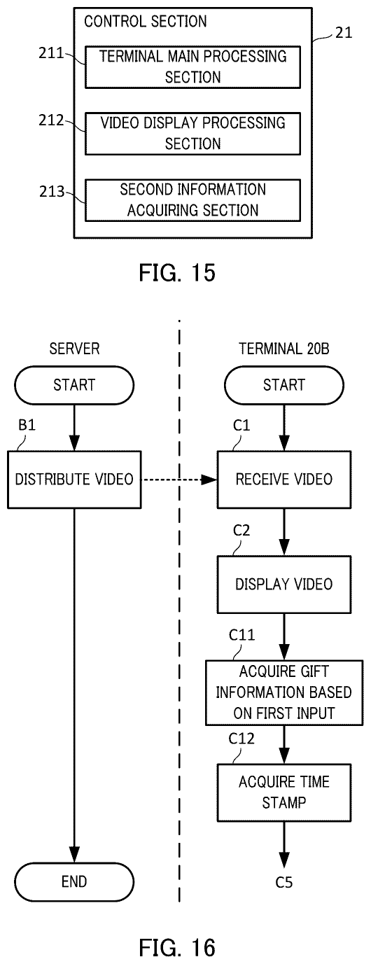

FIG. 15 is a diagram illustrating an example of a function that is implemented by control section 21 of terminal 20 in first modification (4). Control section 21 includes, by way of example but not limitation, terminal main processing section 211, video display processing section 212, and second information acquiring section 213.

On the basis of the gift information, second information acquiring section 213 executes a process of acquiring a time stamp by generating a time stamp related to video 41. Note that terminal main processing section 211 and video display processing section 212 are the same as those of the first embodiment and therefore the description thereof will be omitted.

### Information Processing

FIG. 16 is a flowchart illustrating an example of a procedure of processes executed by each apparatus in first modification (4).

For example, as in the first embodiment, when video 41 is displayed on display section 24 (C2), control section 21 of terminal 20B acquires gift information on the basis of the first input of user B for gifting of gift 42 (C11). Then, control section 21 of terminal 20B may generate time stamps 43a and 43b by itself on the basis of the acquired gift information. Specifically, control section 21 of terminal 20B does not acquire time stamps 43a and 43b generated by server 10, but acquires time stamps 43a and 43b by generating time stamps 43a and 43b by itself on the basis of the gifting time of the gift included in the gift information (C12). Then, control section 21 of terminal 20B controls display section 24 to display acquired time stamps 43a and 43b (C5).

As an example of the effect of such a configuration, the data throughput of server 10 can be suppressed because terminal 20B generates time stamps 43a and 43b.

### Second Embodiment

In the first embodiment, control section 21 of terminal 20B may display on display section 24 a time stamp corresponding to gifting of the gift by another user different from user B. Note that the same configurations as those of the first embodiment are denoted with the same reference numerals, and the overlapping description is omitted. The details of the second embodiment are applicable to any of other embodiments.

### Information Processing

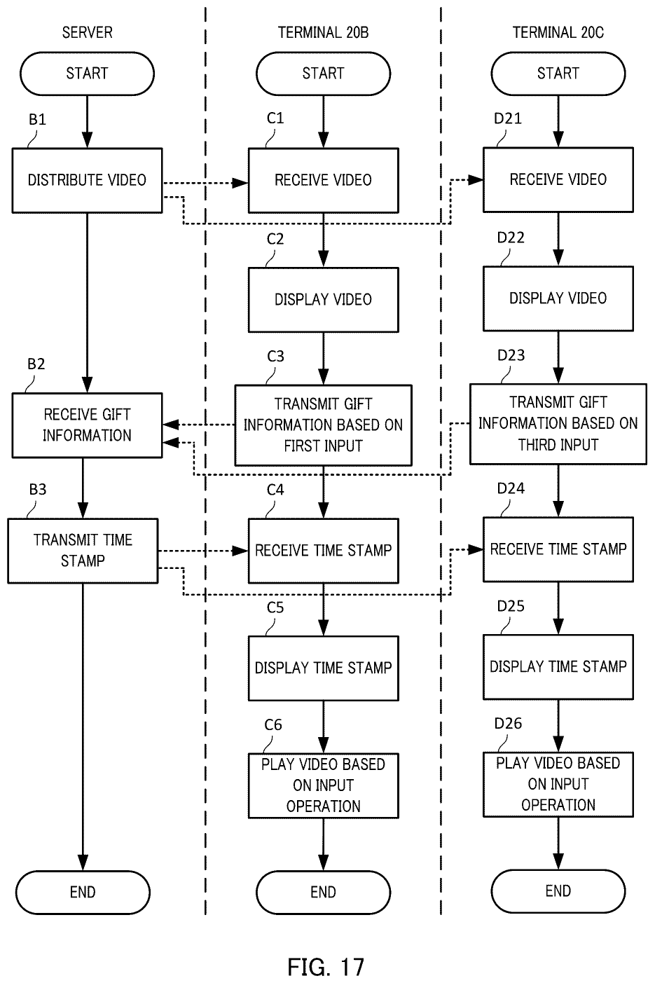

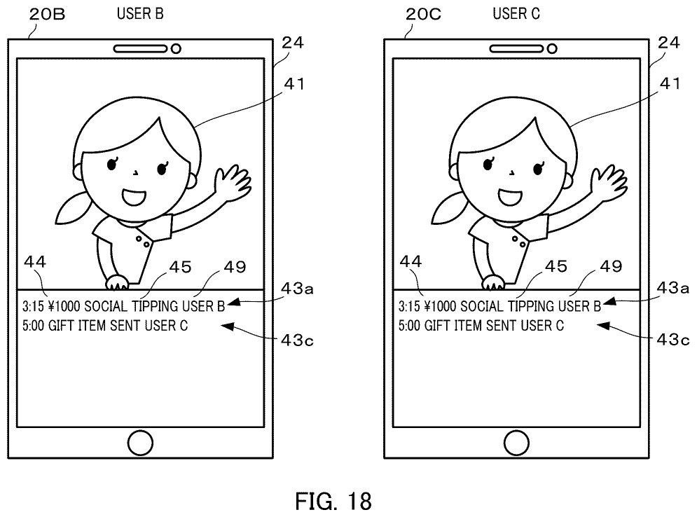

FIG. 17 is a flowchart illustrating an example of a procedure of processes executed by each apparatus in the present embodiment. Note that terminal 20C is an example of the present disclosure.

First, as in the first embodiment, control section 11 of server 10 distributes a video to terminal 20B (B1). At this time, control section 11 of server 10 distributes a video also to terminal 20C. The video distributed from server 10 is received by communication section 22 of terminal 20B (C1), and received by communication section 22 of terminal 20C (D21). Note that steps C1 to C3 are the same as those of the first embodiment, and therefore the description thereof will be omitted.

When receiving a video from server 10, control section 21 of terminal 20C displays the distributed video on display section 24 as with terminal 20B illustrated in FIG. 9 (D22). In this manner, video 41 distributed from server 10 is viewed by user C. Here, it is assumed that user C has performed a third input for gifting of gift 42 to display section 24 displaying video 41 during the distribution of video 41. When acquiring gift information based on the third input, control section 21 of terminal 20C transmits this gift information to server 10 (D23).

When the gift information of terminals 20B and 20C is received by communication section 14, control section 11 of server 10 displays in a superimposed manner gift 42 on video 41 distributed to terminals 20B and 20C. Then, control section 11 of server 10 generates a time stamp for playing the part corresponding to the first input of user B in video 41 on the basis of the gift information of terminal 20B. In addition, control section 11 of server 10 generates a time stamp for playing the part corresponding to the third input of user C in video 41 as the third information related to video 41 on the basis of the gift information of terminal 20C.

Subsequently, control section 11 of server 10 transmits the generated time stamp to terminals 20B and 20C (B3). At this time, control section 11 of server 10 transmits to terminal 20B the time stamp of terminal 20B and the time stamp of terminal 20C. Likewise, control section 11 of server 10 transmits to terminal 20C the time stamp of terminal 20B and the time stamp of terminal 20C.

The time stamp sent from server 10 is received by communication section 22 of terminal 20B (C4), and received by communication section 22 of terminal 20C (D24). In this manner, as illustrated in FIG. 18, control section 21 of terminal 20B controls display section 24 to display time stamp 43a of user B and time stamp 43c of user C (C5). Likewise, control section 21 of terminal 20C controls display section 24 to display time stamp 43a of user B and time stamp 43c of user C (D25). Note that control section 11 of server 10 may or may not send time stamps 43a and 43c to one of terminals 20B and 20C, e.g., to only terminal 20B. Here, by way of example but not limitation, time stamps 43a and 43c may or may not include user identification information for determining the user who has performed the gifting of gift 42. The user identification information needs only to identify the user corresponding to the time stamp, and examples of the user identification information include the user name (e.g., real name and nickname), the user number, icons and the like.

Subsequently, when the input operation of time stamp 43a is performed, control section 21 of terminal 20B controls display section 24 to play the part corresponding to the first input of time stamp 43a in video 41 on the basis of the input operation (C6). At this time, when the input operation of time stamp 43c of user C is performed, control section 21 of terminal 20B controls display section 24 to play the part corresponding to the third input of time stamp 43c in video 41 on the basis of the input operation (C6). Likewise, when the input operation of time stamp 43a or 43c is performed, control section 21 of terminal 20C controls display section 24 to play the part corresponding time stamp 43a or 43c in video 41 on the basis of the input operation (D26).

### Effects of Second Embodiment

In the second embodiment, control section 21 of terminal 20B acquires time stamp 43c (which is, by way of example but not limitation, an example of the information representing the play position) representing the play position of video 41 corresponding to the third input on display section 24 of terminal 20C displaying video 41 by user C of terminal 20C different from terminal 20B. Then, control section 21 of terminal 20B displays time stamp 43c on display section 24. As an example of the effect of such a configuration, user B can easily look back the scene where gifting of gift 42 is performed by other user C.

In addition, in the second embodiment, time stamps 43a and 43c may include user identification information for determining the user who has performed the gifting of gift 42. As an example of the effect of such a configuration, user B can easily distinguish time stamp 43a of user B and time stamp 43c of other users.

### Second Modification (1)

In the second embodiment, control section 21 of terminal 20B may cause user B to select the time stamp of other users displayed on display section 24. Second modification (1) is a modification in which the time stamp of other users selected by user B is displayed on display section 24.

For example, control section 21 of terminal 20B may or may not cause display section 24 to selectively display time stamp 43c of user C selected by user B, e.g., user C registered as “friend”, from among all users who have performed the gifting of gift 42 to video 41. Here, the “friend” may be a specific user C set by user B among the users whose user information is stored in terminal 20B, and may be specific user C who has been set as a partner to exchange contents between the users in a chat and the like, for example.

In addition, control section 21 of terminal 20B may or may not cause display section 24 to selectively display time stamp 43c of user C associated with user B by following the account, for example. Here, user C associated with user B by following the account may be user C followed by user B, user C who follows user B, or user C who follows and is followed by user B, for example. Note that the term “follow” may mean associating the account of one user with the account of another user on the Internet (associating another user with one user), for example. In this manner, the follower user has a relationship that allows for browsing of the information disclosed by the followed user and the like.

In this manner, at step B3, control section 11 of server 10 transmits to terminal 20B time stamp 43a of user B and time stamp 43c of user C selected by user B. Thus, on display section 24 of terminal 20B, only time stamps 43a and 43c of users B and C are displayed from among the time stamps of all users who view video 41.

### Effects of Second Modification (1)

In second modification (1), control section 21 of terminal 20B controls display section 24 to selectively display time stamps 43a and 43c of users B and C from among the time stamps of all users who have performed the gifting of gift 42 to video 41. As an example of the effect of such a configuration, user B can easily look back the scene where gifting of gift 42 is performed regarding user C.

### Second Modification (2)

In the second embodiment, control section 21 of terminal 20B displays time stamp 43a of user B on display section 24, but this is not limitative as long as time stamp 43c of other user C is displayed on display section 24. Second modification (2) is a modification in which only time stamp 43c of other user C is displayed on display section 24.

For example, as illustrated in FIG. 17, control section 11 of server 10 receives gift information as in the second embodiment (B2). Here, control section 11 of server 10 may or may not generate only time stamp 43c of user C on the basis of the gift information sent from terminal 20C. At this time, control section 21 of terminal 20B may not transmit to server 10 the gift information on the basis of the first input. That is, control section 21 of terminal 20B may exclude step C3.

Subsequently, control section 11 of server 10 may transmit the generated time stamp 43c of user C to one of terminals 20B and 20C, e.g., to only terminal 20B (B3). In this manner, when time stamp 43c is received by communication section 22 (C4), control section 21 of terminal 20B displays that time stamp 43c on display section 24 (C5).

### Effects of Second Modification (2)

In second modification (2), control section 21 of terminal 20B displays only time stamp 43c of other user C different from user B on display section 24. As an example of the effect of such a configuration, user B can easily look back the scene where gifting of a gift is sent by other user C.

### Third Embodiment

In the first embodiment and the second embodiment, control section 21 of terminal 20B may create a playlist in which the time stamp selected by user B is registered. Note that the same configurations as those of the first embodiment and the second embodiment are denoted with the same reference numerals, and the overlapping description is omitted. The details of the third embodiment are applicable to any of other embodiments.

### Information Processing

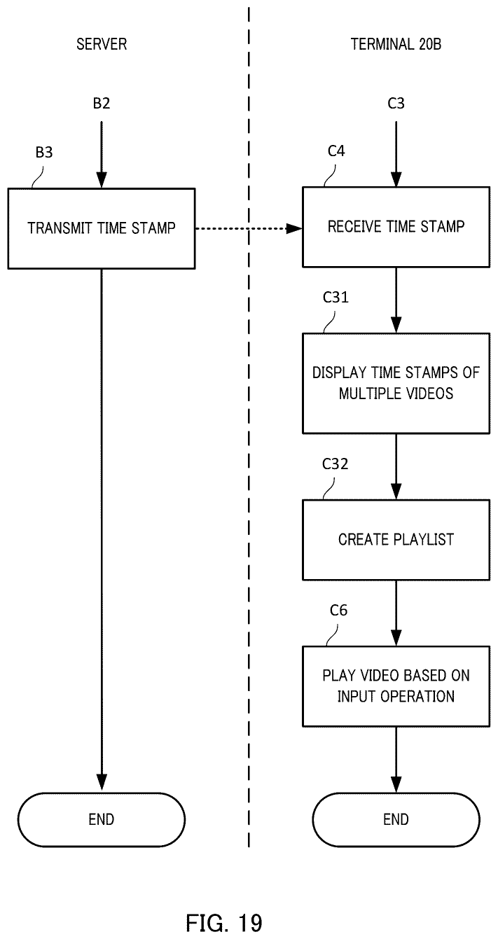

FIG. 19 is a flowchart illustrating an example of a procedure of processes executed by each apparatus in the present embodiment.

First, as in the first embodiment, when the time stamp sent from server 10 received by communication section 14 (C4), control section 21 of terminal 20B stores the time stamp in storage section 28. Here, it is assumed that user B has viewed a plurality of videos and performed the first input for the plurality of videos. As a result, storage section 28 stores a plurality of time stamps corresponding to the plurality of first inputs.

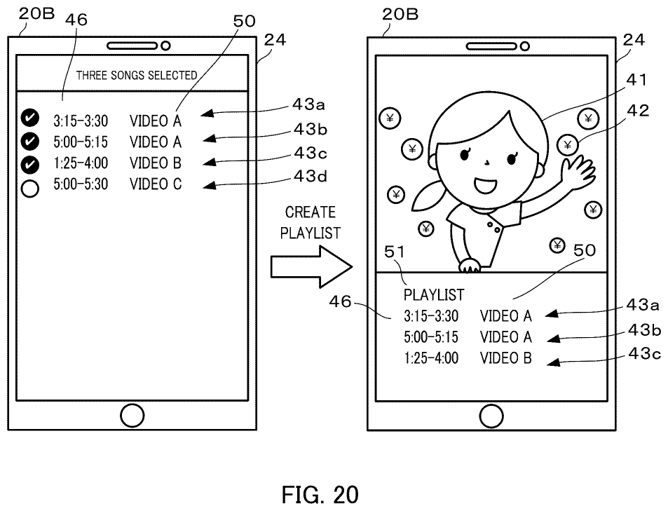

Subsequently, as illustrated in FIG. 20, control section 21 of terminal 20B displays on display section 24 a plurality of time stamps 43a to 43d corresponding to the plurality of first inputs in accordance with the operation of user B (C31). At this time, time stamps 43a to 43d may or may not include video identification information 50 for identifying videos. In addition, time stamps 43a to 43d may or may not include time-period information 46 related to the time period.

Subsequently, user B selects the desired time stamp from among time stamps 43a to 43d to create a playlist. Here, it is assumed that user B has selected time stamp 43a for playing “3:15 to 3:30” of video A, time stamp 43b for playing “5:00 to 5:15” of video A, and time stamp 43c for playing “1:25 to 4:00” of video B.

Control section 21 of terminal 20B creates playlist 51 where time stamps 43a to 43c are registered on the basis of the user B's selection (C32). This playlist 51 is for playing the parts corresponding registered time stamps 43a to 43c. For example, playlist 51 may or may not be configured to sequentially continuously play the parts corresponding to time stamps 43a to 43c, i.e., play the parts as a series of videos.

In addition, control section 21 of terminal 20B may or may not change the information about time stamps 43a to 43c registered in playlist 51 after playlist 51 has once created. For example, control section 21 of terminal 20B can change the order of time stamps 43a to 43c registered in playlist 51, i.e., the order of play, in accordance with the user B's operation. In addition, control section 21 of terminal 20B can change the time-period information 46 about time stamps 43a to 43c registered in playlist 51 in accordance with the user B's operation.

In this manner, when playlist 51 including time stamps 43a to 43c is displayed on display section 24, control section 21 of terminal 20B controls display section 24 to play the part corresponding to each first input among a plurality of videos in accordance with the user B's input operation for playlist 51 (C6). More specifically, control section 21 plays the part “3:15 to 3:30” of “video A” corresponding to the first input of time stamp 43a, and thereafter plays the part “5:00 to 5:15” of “video A” corresponding to the first input of time stamp 43b. Subsequently, control section 21 plays the part “1:25 to 4:00” of “video B” corresponding to the first input of time stamp 43c.

### Effects of Third Embodiment

In the third embodiment, the first input includes multiple inputs, and control section 21 of terminal 20B controls display section 24 to play the part corresponding to each first input in the video in accordance with the input for time stamps 43a to 43c of user B of terminal 20B. As an example of the effect of such a configuration, user B can easily look back the desired portion corresponding to time stamps 43a to 43c.

### Third Modification (1)

In the third embodiment, control section 21 of terminal 20B creates playlist 51 for playing the part corresponding to the first input of a plurality of videos, but in the case where a plurality of first inputs is performed in one video, a playlist for playing the parts corresponding to the plurality of first inputs may be created. Third modification (1) is a modification in which a playlist for one video is created.

For example, when time stamps 43a and 43b representing the same video identification information 50 are selected by user B from among time stamps 43a to 43d, control section 21 of terminal 20B may or may not create a playlist in which time stamps 43a and 43b are registered. In this manner, control section 21 of terminal 20B plays the part “3:15 to 3:30” corresponding to the first input of time stamp 43a, and thereafter plays the part “5:00 to 5:15” corresponding to the first input of time stamp 43b, in video A on the basis of the created playlist.

As an example of the effect of such a configuration, user B can easily look back the desired portion corresponding to time stamps 43a and 43b in one video A.

### Third Modification (2)

In the third embodiment, playlist 51 is created by control section 21 of terminal 20B, but it may be created by server 10. Third modification (2) is a modification in which server 10 creates playlist 51.

For example, as in the third embodiment, control section 21 of terminal 20B displays a plurality of time stamps 43a to 43d on display section 24 to create a playlist (C31). Here, when user B selects time stamps 43a to 43c to be registered in a playlist, control section 21 of terminal 20B may or may not transmit the selected information to server 10.

In this manner, control section 11 of server 10 creates playlist 51 including a list of time stamps 43a to 43c on the basis of the selected information sent from terminal 20B. Playlist 51 created by server 10 is transmitted to terminal 20B, and control section 21 of terminal 20B displays playlist 51 on display section 24.

As an example of the effect of such a configuration, the data throughput of terminal 20B can be suppressed because playlist 51 is created by server 10.

### Fourth Embodiment

In the first embodiment to the third embodiment, the information representing the play position is configured to include time stamps, but this is not limitative as long as the information representing the play position for the first input is included. In the fourth embodiment, the information representing the play position on a seek bar of video 41 is displayed on display section 24. Note that the same configurations as those of the first embodiment to the third embodiment are denoted with the same reference numerals, and the overlapping description is omitted. The details of the fourth embodiment are applicable to any of other embodiments.

### Information Processing

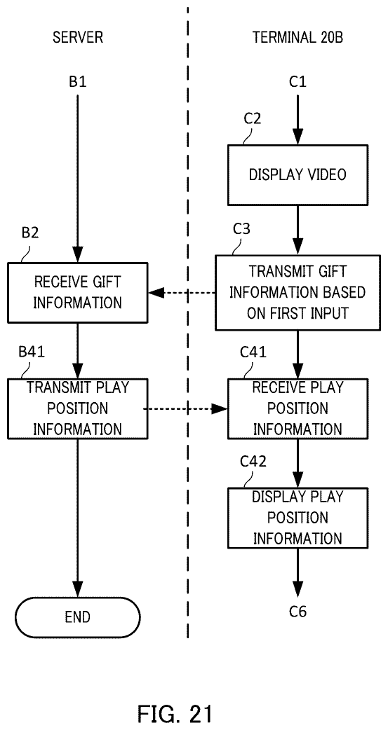

FIG. 21 is a flowchart illustrating an example of a procedure of processes executed by each apparatus in the present embodiment.

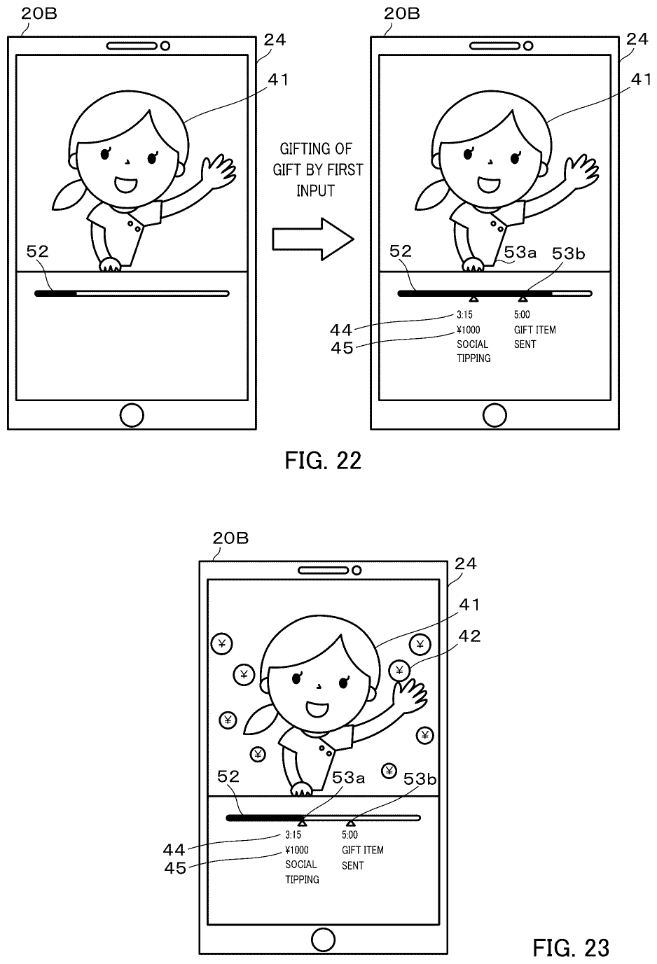

First, as in the first embodiment, control section 21 of terminal 20B displays video 41 distributed from server 10 on display section 24 (C2). At this time, as illustrated in FIG. 22, control section 21 of terminal 20B displays seek bar 52 indicating the play position of video 41 on display section 24. Seek bar 52 may or may not be configured to indicate the time of the current play position with respect to the entire play time period of video 41 with a slider, for example.

Subsequently, when acquiring gift information based on the first input of user B, control section 21 of terminal 20B transmits this gift information to server 10 (C3). Then, when receiving the gift information sent from terminal 20B (B2), control section 11 of server 10 may be generate play location information 53a and play location information 53b representing the play position on seek bar 52 of video 41 on the basis of the gift information.

Here, it is assumed that user B has performed the first input two times on video 41, and two pieces of play location information 53a and play location information 53b corresponding to the two first inputs have been generated. That is, play location information 53a and play location information 53b represent the play positions corresponding to the first input of user B in video 41, and may include control information for moving the screen of video 41 to that play position, for example. In addition, play location information 53a and play location information 53b may include time information 44 representing the time of the play position, and content information 45 representing the content of gift 42. For example, play location information 53a may include time information 44 representing “3:15”, and content information 45 of “1,000 yen social tipping”. In addition, play location information 53b may include time information 44 representing “5:00”, and content information 45 of “gift item sent”.

Control section 11 of server 10 transmits the generated play location information 53a and play location information 53b to terminal 20B (B41). Play location information 53a and play location information 53b sent from server 10 are received by communication section 22 of terminal 20B (C41), and stored in storage section 28 of terminal 20B. In this manner, control section 21 of terminal 20B acquires play location information 53a and play location information 53b representing the play position corresponding to the first input of the gifting of sent gift 42 on the basis of the gift information. Then, as illustrated in FIG. 22, control section 21 of terminal 20B displays acquired play location information 53a and play location information 53b in accordance with seek bar 52 (C42).

Subsequently, when user B desires to again view the scene where the gifting of gift 42 has been performed in video 41, user B inputs play location information 53a and play location information 53b. As illustrated in FIG. 23, when play location information 53a is input, control section 21 of terminal 20B controls display section 24 to play the part corresponding to the first input of play location information 53a in video 41 on the basis of the input operation (C6).

### Effects of Fourth Embodiment

In the fourth embodiment, the information representing the play position includes play location information 53a and play location information 53b representing the play position on seek bar 52 of video 41 (which is, by way of example but not limitation, an example of the information representing the play position on the seek bar). As an example of the effect of such a configuration, control section 21 of terminal 20B can more easily and correctly play the scene where gifting of gift 42 is performed in video 41.

### Fourth Modification (1)

In the fourth embodiment, control section 21 of terminal 20B receives play location information 53a and play location information 53b generated by server 10, but this is not limitative as long as play location information 53a and play location information 53b can be acquired. Fourth modification (1) is a modification in which control section 21 of terminal 20B generates play location information 53a and play location information 53b.

### Information Processing

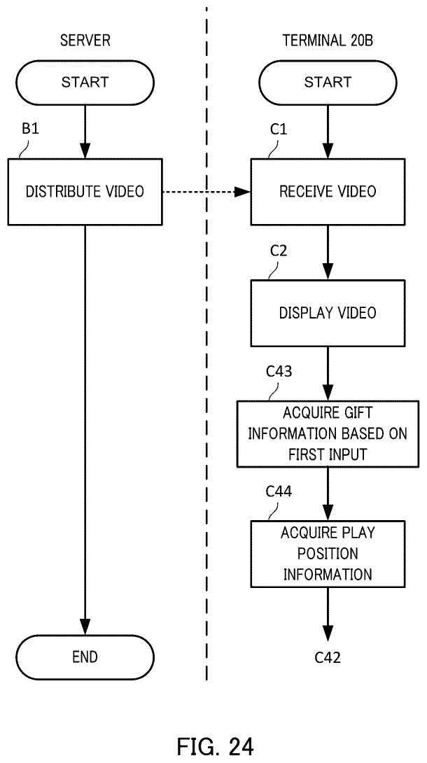

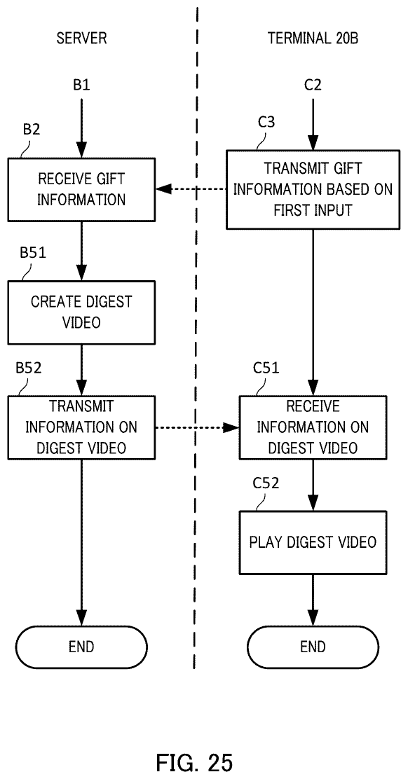

FIG. 24 is a flowchart illustrating an example of a procedure of processes executed by each apparatus in fourth modification (1).

For example, as in the fourth embodiment, when video 41 is displayed on display section 24 (C2), control section 21 of terminal 20B acquires gift information on the basis of the first input of user B for gifting of gift 42 (C43). Then, control section 21 of terminal 20B may generate play location information 53a and play location information 53b by itself on the basis of the acquired gift information. Specifically, control section 21 of terminal 20B does not acquire play location information 53a and play location information 53b generated by server 10, but acquires play location information 53a and play location information 53b by generating the information by itself on the basis of the gifting time of the gift included in the gift information (C44). Then, as illustrated in FIG. 22, control section 21 of terminal 20B displays the acquired play location information 53a and play location information 53b in accordance with seek bar 52 (C42).

As an example of the effect of such a configuration, the data throughput of server 10 can be suppressed because terminal 20B generates play location information 53a and play location information 53b.

### Fifth Embodiment

In the first embodiment to the fourth embodiment, the second information is configured to include information representing the play position corresponding to the first input of user B, but this is not limitative as long as it is information related to video 41. In the fifth embodiment, a digest video corresponding to the first input of user B is created, and its digest video is played. Note that the same configurations as those of the first embodiment to the fourth embodiment are denoted with the same reference numerals, and the overlapping description is omitted. The details of the fifth embodiment are applicable to any of other embodiments.

### Information Processing

FIG. 25 is a flowchart illustrating an example of a procedure of processes executed by each apparatus in the present embodiment.

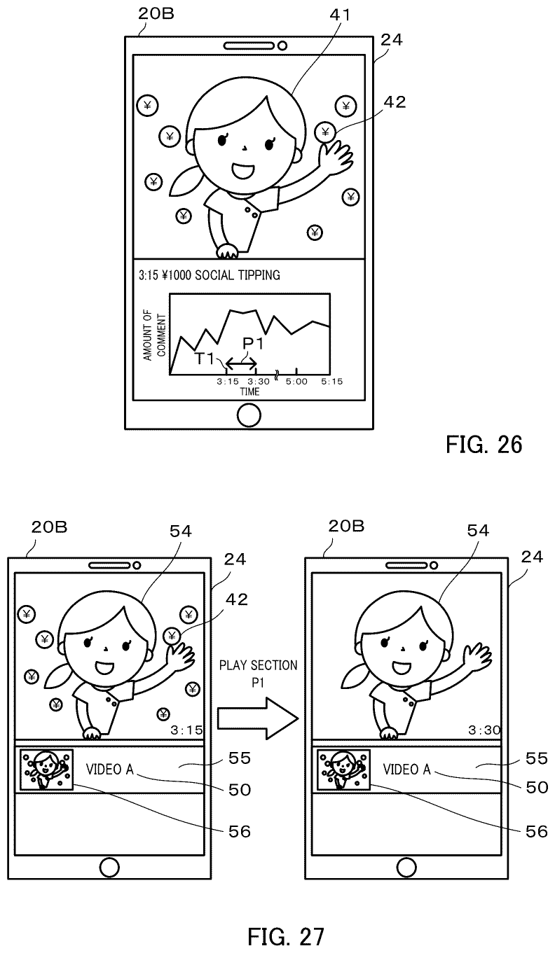

First, as in the first embodiment, control section 11 of server 10 receives from terminal 20B gift information based on the first input of user B (B2). Here, it is assumed that user B has performed first input T1 of gifting of social tipping gift 42 at time “3:15” as illustrated in FIG. 26.

Subsequently, control section 11 of server 10 creates a digest video for playing the part corresponding to first input T1 of user B as the second information related to video 41 on the basis of the received gift information (B51). At this time, control section 11 of server 10 may create a digest video of at least an extracted part of video 41 on the basis of first input T1. Note that the digest video may be created by extracting the part corresponding to first input T1 from video 41. For example, the digest video may or may not be created by editing video 41 to extract the part corresponding to first input T1. At this time, the digest video may be obtained by extracting only the part corresponding to first input T1 from video 41. In addition, the digest video may be obtained by extracting a range including the part corresponding to first input T1 from video 41.

More specifically, control section 11 of server 10 may or may not create a digest video including the scene where gifting of gift 42 is performed by extracting the vicinity of the time “3:15” where first input T1 has been performed in video 41. For example, control section 11 of server 10 may set the start point of the extraction of section P1 that is a part of video 41 on the basis of the time “3:15” where first input T1 has been performed. For example, control section 11 of server 10 may or may not set, as the start point of the extraction of section P1 of video 41, a time that is earlier by a predetermined time than the time “3:15” where first input T1 has been performed.

In addition, by way of example but not limitation, control section 11 of server 10 may set the end point at a point later by a predetermined time than the start point of the extraction of section P1 of video 41. In this case, by way of example but not limitation, control section 11 of server 10 may or may not set the end point of the extraction of section P1 of video 41 on the basis of at least one of the amount of the comment of the user (such as the amount of comment and the number of letters), the distributor's voice (such as the volume), and the distributor's facial expression (such as the size of the mouth or eyes, and the number of movements), to the distributor of video 41 distributed from server 10.

For example, control section 11 of server 10 may calculate the change in the amount of comment with respect to the distribution period on the basis of the information about video 41. Then, control section 11 of server 10 may set, as the end point of the extraction of section P1 of video 41, the time “3:30” where the amount of increase in the amount of comment from the time “3:15” of first input T1 is equal to or greater than a predetermined value.

In addition, by way of example but not limitation, control section 11 of server 10 may detect a voice related to first input T1 such as “user B” by analyzing the distributor's voice on the basis of the information about video 41. For example, in the case where a voice “Thank you user B” is detected after first input T1, control section 11 of server 10 may set, as the end point of the extraction of section P1 of video 41, the time “3:30”, which is a time later by a predetermined time than the time when that voice is detected.

In addition, by way of example but not limitation, control section 11 of server 10 may analyze the distributor's facial expression on the basis of the information about video 41. In general, when gifting of gift 42 is performed, the facial expression of the distributor's mouth, eyes, and the like significantly change such as when responding to the user who has performed the gifting of gift 42. In view of this, control section 11 of server 10 may set, as the end point of the extraction of section P1 of video 41, the time “3:30” where the size and/or the number of movements of the distributor's mouth changes by a predetermined value or more, for example.

In this manner, control section 11 of server 10 creates a digest video of an extraction of section P1 of video 41 as the second information related to video 41. Subsequently, control section 11 of server 10 transmits information about the created digest video to terminal 20B (B52).

The information about the digest video sent from server 10 is received by communication section 22 of terminal 20B (C51), and stored in storage section 28 of terminal 20B. In this manner, control section 21 of terminal 20B acquires information about a digest video of an extraction of section P1 of video 41 on the basis of the gift information.

In addition, when acquiring the information about the digest video, control section 21 of terminal 20B displays play button 55 for playing digest video 54 on display section 24 as illustrated in FIG. 27. Here, by way of example but not limitation, play button 55 may or may not include information of thumbnail 56 obtained by visualizing a predetermined part of digest video 54 for the purpose of increasing the visibility. In addition, play button 55 may or may not include video identification information 50 for identifying digest video 54 such as the name of video 41.

Subsequently, control section 21 of terminal 20B controls display section 24 to play digest video 54 on the basis of the input of user B on play button 55 (C52). In this manner, display section 24 plays section P1 of video 41. For example, digest video 54 plays the section P1 of video 41 starting from the time “3:15” where social tipping gifting of gift 42 is performed by user B, to the time “3:30” where the reaction of the user or the distributor is significant.

### Effects of Fifth Embodiment

In the fifth embodiment, the second information includes information about digest video 54 (which is, by way of example but not limitation, an example of the first video) of at least an extracted part of video 41 on the basis of first input T1. Then, control section 21 of terminal 20B performs a control of playing digest video 54 on display section 24 on the basis of the input on play button 55 (which is, by way of example but not limitation, an example of the second information) performed by user B of terminal 20B. As an example of the effect of such a configuration, user B can easily look back the scene where gifting of gift 42 is performed in video 41.

In addition, in the fifth embodiment, the start point of digest video 54 (which is, by way of example but not limitation, an example of the first video) may be set on the basis of the time point when the first input is performed. As an example of the effect of such a configuration, user B can reliably look back the scene where gifting of gift 42 is performed in video 41.

In addition, in the fifth embodiment, the end point of digest video 54 (which is, by way of example but not limitation, an example of the first video) may be set on the basis of at least one of the amount of the comment of the user, the distributor's voice, and the distributor's facial expression to the distributor of video 41 distributed from server 10. As an example of the effect of such a configuration, user B can look back the part where the reaction of the distributor and/or the user is significant in video 41.

In addition, in the fifth embodiment, play button 55 (which is, by way of example but not limitation, an example of the second information) may include information about thumbnail 56 corresponding to digest video 54. As an example of the effect of such a configuration, user B can easily determine the content of digest video 54.

### Fifth Modification (1)

In the fifth embodiment, digest video 54 may be created by thinning out a predetermined part between the start point and the end point of section P1.

For example, as in the fifth embodiment, control section 11 of server 10 creates digest video 54 that is obtained by extracting section P1 of a part of video 41 (B51). In this case, control section 11 of server 10 may or may not create digest video 54 by thinning out a predetermined part of section P1 of digest video 54. For example, in the case where the time between the start point and the end point of section P1 is longer than a predetermined time, control section 11 of server 10 may create digest video 54 by thinning out a predetermined part between the start point and the end point. Note that control section 11 of server 10 may thin out one location or a plurality of locations between the start point and the end point of section P1.

Here, control section 11 of server 10 may determine the predetermined part where digest video 54 is to be thinned out on the basis of at least one of the amount of the comment of the user (such as the amount of comment and the number of letters), the distributor's voice (such as the volume), and the distributor's facial expression (such as the size of the mouth or eyes, and the number of movements) to the distributor of video 41 distributed from server 10.

For example, control section 11 of server 10 may calculate change in the amount of comment posted by the user to the distributor in section P1 of digest video 54. Then, control section 11 of server 10 may create digest video 54 by thinning out the part where the amount of comment decreases by a predetermined value or more.

In addition, by way of example but not limitation, control section 11 of server 10 may detect voices not related to first input T1, e.g., voices calling the names of users other than user B by analyzing the distributor's voice in section P1 of digest video 54. Then, in the case where a voice “Thank you user C” is detected, control section 11 of server 10 may create digest video 54 by thinning out the part where that voice is detected.

In addition, by way of example but not limitation, control section 11 of server 10 may analyze the distributor's facial expression in section P1 of digest video 54. For example, in the case where a change in the size and/or the number of movements of the distributor's mouth has decreased to a predetermined value or smaller, control section 11 of server 10 may create digest video 54 by thinning out the part where the change in facial expression has decreased.

In this manner, after creating digest video 54 obtained by thinning out a predetermined part, control section 11 of server 10 transmits that digest video 54 to terminal 20B (B52).

### Effects of Fifth Modification (1)

In fifth modification (1), digest video 54 is set by thinning out a predetermined part between the start point of digest video 54 and the end point of digest video 54. As an example of the effect of such a configuration, user B can efficiently look back the scene where gifting of gift 42 is performed in video 41.

In addition, in fifth modification (1), in the case where the time between the start point and the end point of digest video 54 is longer than a predetermined time, control section 11 of server 10 may create digest video 54 obtained by thinning out a predetermined part. As an example of the effect of such a configuration, user B can efficiently look back the scene where gifting of gift 42 is performed in video 41.

In addition, in fifth modification (1), control section 11 of server 10 may determine the predetermined part where digest video 54 is to be thinned out on the basis of at least one of the amount of the comment of the user, the distributor's voice, and the distributor's facial expression to the distributor of video 41 distributed from server 10. As an example of the effect of such a configuration, user B can more efficiently look back the scene where gifting of gift 42 is performed in video 41.

### Fifth Modification (2)

In the fifth embodiment, in digest video 54, the start point or end point of section P1 or the thinning location may be modified by user B.

For example, as in the fifth embodiment, when digest video 54 sent from server 10 is received by communication section 22 (C51), control section 21 of terminal 20B plays that digest video 54 in accordance with the input operation of user B (C52). Then, when an instruction of modifying the start point or end point of section P1 in digest video 54 is input from user B, control section 21 of terminal 20B may or may not transmit that modification information to server 10. In addition, when an instruction of modifying the thinning out part between the start point and the end point of digest video 54 is input from user B, control section 21 of terminal 20B may or may not transmit that modification information to server 10. Note that the modification information may include the time for modifying the start point, the end point or the thinning out part, and the like, for example.

When the modification information transmitted from terminal 20B is received by communication section 14, control section 11 of server 10 modifies digest video 54 on the basis of that modification information. Then, control section 11 of server 10 transmits the modified digest video 54 to terminal 20B. In this manner, control section 21 of terminal 20B plays the modified digest video 54 in accordance with the input operation of user B.

### Effects of Fifth Modification (2)

In fifth modification (2), digest video 54 is configured such that the start point or end point of section P1 can be modified by user B. As an example of the effect of such a configuration, user B can acquire the desired digest video 54.

In addition, in fifth modification (2), digest video 54 may be configured such that the thinning out part between the start point and the end point of section P1 can be modified by user B. As an example of the effect of such a configuration, user B can acquire the desired digest video 54.

### Fifth Modification (3)

In the fifth embodiment, control section 21 of terminal 20B receives digest video 54 created by server 10, but this is not limitative as long as digest video 54 (which is, by way of example but not limitation, an example of the second information) can be acquired. Fifth modification (3) is a modification in which control section 21 of terminal 20B generates digest video 54 on the basis of the gift information based on the first input.

### Information Processing

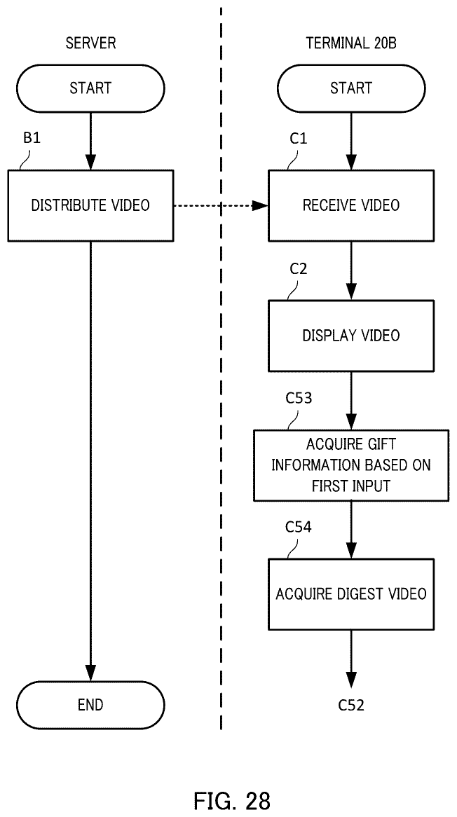

FIG. 28 is a flowchart illustrating an example of a procedure of processes executed by each apparatus in fifth modification (3).

First, as in the fifth embodiment, when video 41 is displayed on display section 24 (C2), control section 21 of terminal 20B acquires gift information on the basis of the first input of user B for gifting of gift 42 (C53). Then, control section 21 of terminal 20B may generate digest video 54 by itself on the basis of the acquired gift information. Specifically, control section 21 of terminal 20B does not acquire digest video 54 generated by server 10, but acquires digest video 54 by generating it by itself on the basis of the gifting time of the gift included in the gift information (C54). Then, it controls display section 24 to play digest video 54 in accordance with the input operation of user B (C52).

As an example of the effect of such a configuration, the data throughput of server 10 can be suppressed because terminal 20B generates digest video 54.

### Fifth Modification (4)

In the fifth embodiment, in the case where a plurality of first inputs is performed, control section 21 of terminal 20B may acquire and play digest video 54 corresponding to the plurality of first inputs. Fifth modification (4) is a modification in which a plurality of digest videos 54 corresponding to the plurality of first inputs is created.

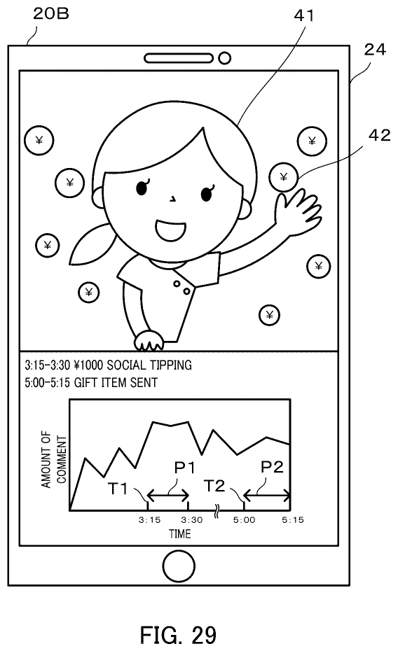

For example, as in the first embodiment, control section 11 of server 10 receives from terminal 20B gift information based on the first input of user B (B2). Here, it is assumed that as illustrated in FIG. 29, user B has performed first input T1 for gifting of social tipping gift 42 at time “3:15”, and performed first input T2 for gifting of gift 42 of a gift item at time “5:00”.

Then, control section 11 of server 10 may create from video 41 two digest videos 54 obtained by extracting the parts corresponding first inputs T1 and T2 of user B as the second information related to video 41 on the basis of the received gift information, (B51). For example, control section 11 of server 10 may create two digest videos 54 obtained by extracting sections P1 and P2 of video 41 corresponding to first inputs T1 and T2. Control section 11 of server 10 transmits the created two digest videos 54 to terminal 20B (B52).

In this manner, control section 21 of terminal 20B receives two digest videos 54 obtained by extracting sections P1 and P2 of video 41 (C51). Then, control section 21 of terminal 20B controls display section 24 to play digest video 54 on the basis of the input of user B on play button 55 (C52). For example, in the case where digest video 54 corresponding to first input T1 is selected, control section 21 of terminal 20B controls display section 24 to play section P1 of video 41. On the other hand, in the case where digest video 54 corresponding to first input T2 is selected, control section 21 of terminal 20B controls display section 24 to play section P2 of video 41.

### Effects of Fifth Modification (4)

In fifth modification (4), the second information includes information about a plurality of digest videos 54 (which is, by way of example but not limitation, an example of the first video) obtained by extracting respective parts of video 41 on the basis of a plurality of first inputs T1 and T2. As an example of the effect of such a configuration, user B can easily look back the scene where gifting of gift 42 has been performed multiple times in video 41.

### Fifth Modification (5)

In fifth modification (4), a single digest video 54 for continuously playing the parts corresponding to the plurality of first inputs may be created.

For example, as in fifth modification (4), it is assumed that user B has performed first input T1 for gifting of social tipping gift 42 at time “3:15”, and performed first input T2 for gifting of gift 42 of a gift item at time “5:00”. Here, control section 11 of server 10 may create a single digest video 54 that is edited such that the parts corresponding to first input T1 and first input T2 of user B are continuous, i.e., section P1 and section P2 of video 41 are successive on the basis of the gift information received from terminal 20B (B51). Control section 11 of server 10 transmits the created digest video 54 to terminal 20B (B52).

In this manner, control section 21 of terminal 20B receives the single digest video 54 that is extracted such that sections P1 and P2 of video 41 are successive (C51). Then, control section 21 of terminal 20B controls display section 24 to play digest video 54 on the basis of the input of user B on play button 55 (C52). For example, in digest video 54, section P1 from the time “3:15” to the time “3:30” in video 41 is played. Then, in digest video 54, the section from the time “3:30” to the time “5:00” is not played, but section P2 from the “5:00” where user B has performed the gifting of gift 42 of the gift item to the time “5:30” where the reaction of the user or the distributor is significant is played continuously from section P1.

### Effects of Fifth Modification (5)

In fifth modification (5), the second information includes information about a single digest video 54 (which is, by way of example but not limitation, an example of the first video) that is extracted such that the parts corresponding to a plurality of first inputs T1 and T2 are successive. As an example of the effect of such a configuration, user B can easily look back the scene where gifting of gift 42 has been performed multiple times in video 41.

### Sixth Embodiment

In the fifth embodiment, control section 21 of terminal 20B may create a playlist in which a plurality of digest videos selected by user B is registered. Note that the same configurations as those of the first embodiment to the fifth embodiment are denoted with the same reference numerals, and the overlapping description is omitted. The details of the sixth embodiment are applicable to any of other embodiments.

### Information Processing

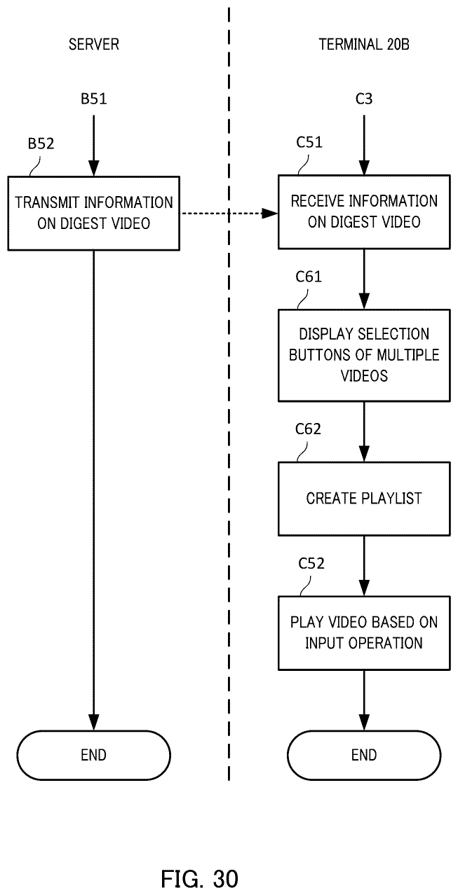

FIG. 30 is a flowchart illustrating an example of a procedure of processes executed by each apparatus in the present embodiment.

First, as in the fifth embodiment, when the digest video sent from server 10 is received by communication section 14 (C51), control section 21 of terminal 20B stores that digest video in storage section 28. Here, it is assumed that user B has viewed a plurality of videos and performed the first input for the plurality of videos. In this manner, storage section 28 stores a plurality of digest videos corresponding to the plurality of first inputs. Specifically, the plurality of digest videos is composed of the part corresponding to each first input in the plurality of videos viewed by user B.

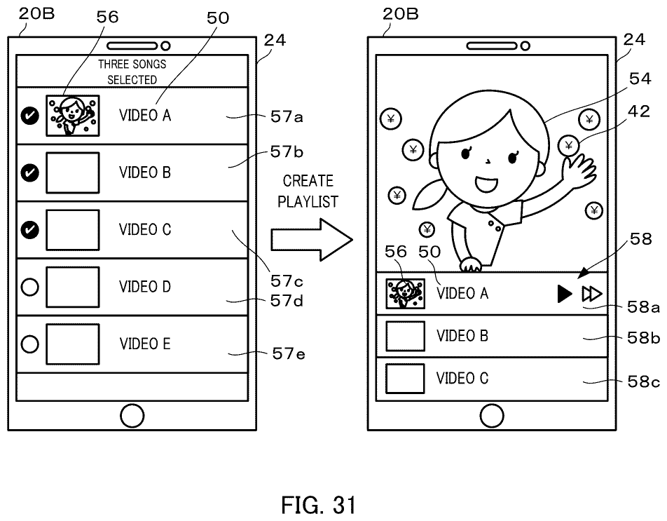

Subsequently, as illustrated in FIG. 31, control section 21 of terminal 20B displays on display section 24 a plurality of selection buttons 57a to 57e for selecting a plurality of digest videos (e.g., digest videos of video A to video E) stored in storage section 28 in accordance with the operation of user B (C61). Selection buttons 57a to 57e are buttons for user B to select a digest video that user B desires to register in playlist 58 from among a plurality of digest videos. Note that selection buttons 57a to 57e may or may not include video identification information 50 for identifying videos. In addition, selection buttons 57a to 57e may or may not include information about thumbnail 56 corresponding to a plurality of digest videos.

Subsequently, to create playlist 58, user B selects the desired digest video by performing input operation on selection buttons 57a to 57e. Here, it is assumed that user B has selected digest videos of video A to video C by performing input operation on selection buttons 57a to 57c.

Control section 21 of terminal 20B creates playlist 58 in which digest videos of video A to video C is registered on the basis of the input operation of selection buttons 57a to 57c (C62). At this time, playlist 58 may or may not include registration information 58a to 58c representing the registered digest videos of video A to video C.

Then, control section 21 of terminal 20B controls display section 24 to play digest videos of video A to video C on the basis of the input operation of user B for playlist 58 (C52). At this time, control section 21 of terminal 20B may or may not continuously play the digest videos of video A to video C registered in playlist 58 in a predetermined order. For example, control section 21 of terminal 20B may continuously play the videos in the order in which the digest videos are registered in playlist 58. In addition, control section 21 of terminal 20B may or may not play the digest video selected by user B from among the digest videos registered in playlist 58. For example, in the case where the digest video of video A is selected by user B, control section 21 of terminal 20B may terminate the operation after playing only the digest video of video A.

Note that control section 21 of terminal 20B may or may not change the information about the digest videos registered in playlist 58 after playlist 58 has been created. For example, control section 21 of terminal 20B may change the order of playing digest videos in accordance with the operation of user B.

### Effects of Sixth Embodiment

In the sixth embodiment, the first input includes a plurality of inputs, and the digest videos (which are, by way of example but not limitation, an example of the first video) of video A to video E are composed of the parts corresponding to each first input in video A to video E. As an example of the effect of such a configuration, user B can easily create a plurality of digest videos 54.

In addition, in the sixth embodiment, control section 21 of terminal 20B may create playlist 58 in which a plurality of digest videos selected by user B is registered. As an example of the effect of such a configuration, user B can easily look back desired digest video 54.

### Sixth Modification (1)

In the sixth embodiment, playlist 58 is created by control section 21 of terminal 20B, but it may be created by server 10. Sixth modification (1) is a modification in which server 10 creates playlist 58.

For example, as in the sixth embodiment, when selection buttons 57a to 57e for selecting digest video 54 are displayed on display section 24 (C61), control section 21 of terminal 20B transmits the selected information of digest video 54 to server 10 on the basis of the user B's selection. Then, control section 11 of server 10 may create playlist 58 in which digest videos of video A to video C is registered on the basis of the selected information sent from terminal 20B. Playlist 58 created by server 10 is transmitted to terminal 20B, and control section 21 of terminal 20B displays playlist 58 on display section 24.

As an example of the effect of such a configuration, the data throughput of terminal 20B can be suppressed because playlist 58 is created by server 10.

### Seventh Embodiment

In the fifth embodiment and the sixth embodiment, control section 21 of terminal 20B may switch the video played on display section 24 from the digest video to original video 41 in accordance with the operation of user B. Note that the same configurations as those of the first embodiment to the sixth embodiment are denoted with the same reference numerals, and the overlapping description is omitted. The details of the seventh embodiment are applicable to any of other embodiments.

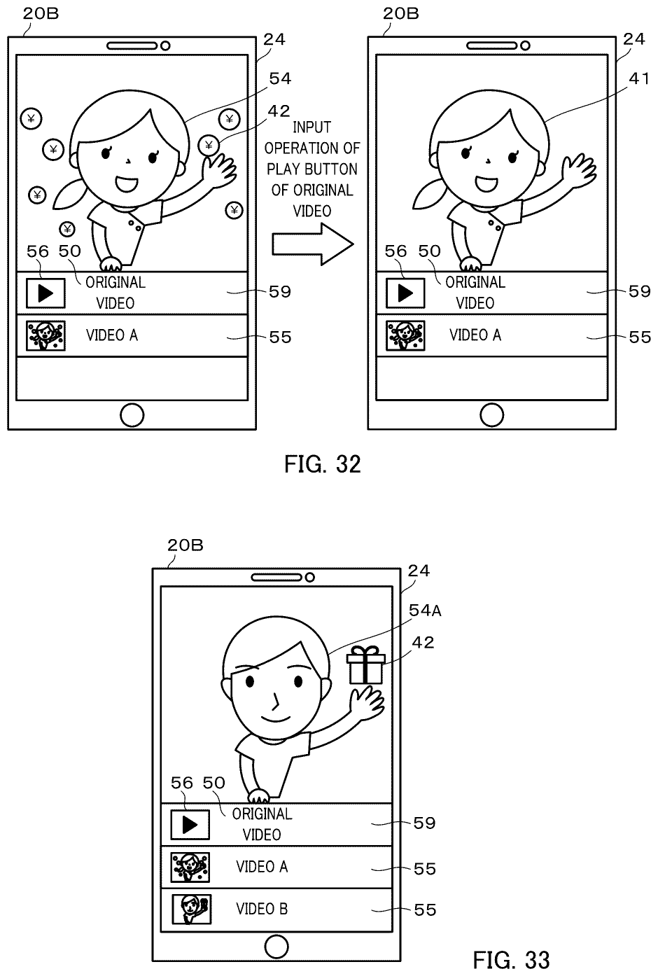

For example, as in the fifth embodiment, when the information about digest video 54 sent from server 10 is received (C51), control section 21 of terminal 20B displays play button 55 for playing digest video 54 on display section 24. Here, as illustrated in FIG. 32, control section 21 of terminal 20B may display on display section 24 play button 59 for playing original video 41 distributed by the distributor. At this time, control section 21 of terminal 20B may or may not control display section 24 to display play button 59 in the vicinity of digest video 54 played on display section 24. In addition, control section 21 of terminal 20B may or may not control display section 24 to display play button 59 in a superimposed manner on digest video 54 played on display section 24. In addition, play button 55 may or may not include control information for playing original video 41 stored in storage section 28 of terminal 20B or storage section 15 of server 10.

Subsequently, control section 21 of terminal 20B controls display section 24 to play digest video 54 on the basis of the input of user B on play button 55 (C52). Then, when an input operation of button 59 is performed by user B while digest video 54 is being played, control section 21 of terminal 20B may control display section 24 to switch the video to be played from digest video 54 to original video A 41. In this manner, display section 24 plays original video A 41.

At this time, control section 21 of terminal 20B may or may not play original video A 41 from the beginning. In addition, control section 21 of terminal 20B may or may not play original video A 41 from the play position of digest video 54 before the switch. In addition, control section 21 of terminal 20B may or may not play original video A 41 from the position selected by user B.

Here, play button 59 plays original video 41 of digest video 54 that is being played on display section 24. In this manner, as illustrated in FIG. 33, when input operation of play button 59 is performed while digest video 54A of video B 41 is being played, control section 21 of terminal 20B controls display section 24 to play video B 41, not video A 41. Note that control section 21 of terminal 20B may display on display sections 24 a plurality of play buttons corresponding to a plurality of original videos 41. Specifically, control section 21 of terminal 20B may display on display section 24 a play button dedicated to play video A 41 and a play button dedicated to play video B 41.

### Effects of Seventh Embodiment

In the seventh embodiment, control section 21 of terminal 20B controls display section 24 to switch the video to be played from digest video 54 to video 41 distributed from server 10 on the basis of the input of user B. As an example of the effect of such a configuration, user B can easily switch the video to be viewed from digest video 54 to original video 41.

In addition, in the seventh embodiment, control section 21 of terminal 20B may display play button 59 in the vicinity of digest video 54 played on display section 24. As an example of the effect of such a configuration, user B can easily switch the video from digest video 54 to original video 41.

In addition, in the seventh embodiment, control section 21 of terminal 20B may display on display section 24 play button 59 for playing original video 41 of digest video 54 played on display section 24. As an example of the effect of such a configuration, user B can easily switch the video from digest video 54 to original video 41 with a single play button 59.

### Seventh Modification (1)

In the seventh embodiment, control section 21 of terminal 20B may switch the video played on display section 24 from digest video 54 of playlist 58 to original video 41 in accordance with the operation of user B.

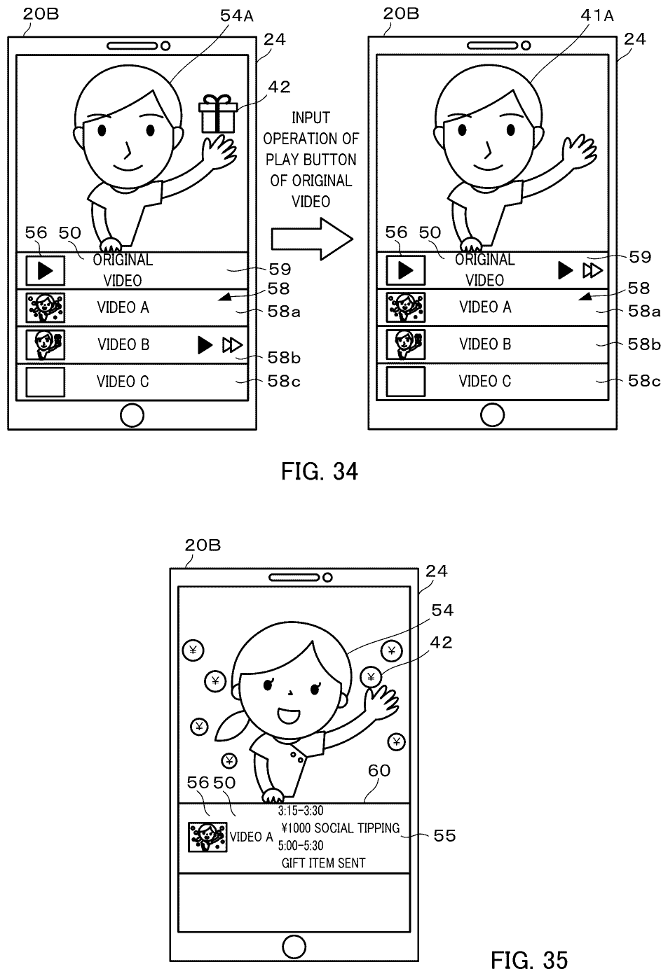

For example, as in the sixth embodiment, control section 21 of terminal 20B creates playlist 58 in which digest videos 54 of video A to video C are registered (C62). Here, as illustrated in FIG. 34, control section 21 of terminal 20B may display on display section 24 play button 59 for playing original video 41 distributed by the distributor.

Subsequently, control section 21 of terminal 20B controls display section 24 to play digest videos 54 of video A to video C on the basis of the input operation of user B for playlist 58 (C52). Then, when an input operation of button 59 is performed by user B while digest video 54 is being played, control section 21 of terminal 20B may control display section 24 to switch the video to be played from digest video 54 to original video 41. For example, when input operation of play button 59 is performed while digest video 54A of video B is being played among digest videos 54 of video A to video C registered in playlist 58, control section 21 of terminal 20B controls display section 24 to play original video B 41A.

At this time, control section 21 of terminal 20B may or may not play original video B 41A from the beginning. In addition, control section 21 of terminal 20B may or may not play original video B 41A from the play position of digest video 54A before the switch. In addition, control section 21 of terminal 20B may or may not play original video B 41A from the position selected by user B.

### Effects of Seventh Modification (1)

In seventh modification (1), control section 21 of terminal 20B controls display section 24 to switch the video to be played from digest video 54 of playlist 58 to video 41 distributed from server 10 on the basis of the input of user B. As an example of the effect of such a configuration, user B can easily switch the video to be viewed from digest video 54 of playlist 58 to original video 41.

### Seventh Modification (2)

In the seventh embodiment, control section 21 of terminal 20B displays play button 59 on display section 24 after receiving the information about digest video 54 sent from server 10, but this is not limitative as long as play button 59 can be displayed on display section 24. Seventh modification (2) is a modification in which play button 59 is displayed on display section 24 of terminal 20B immediately after completion of the video 41 distributed from server 10.

For example, as in the seventh embodiment, control section 21 of terminal 20B displays video 41 distributed from server 10 on display section 24 (C2). Then, when video 41 distributed from server 10 is completed, control section 21 of terminal 20B may or may not control display section 24 to display play button 59 for playing video 41. Subsequently, when receiving the information about digest video 54 sent from server 10 (C51), control section 21 of terminal 20B may display play button 55 for playing digest video 54 on display section 24.

### Effects of Seventh Modification (2)

In seventh modification (2), control section 21 of terminal 20B controls display section 24 to display play button 59 for playing video 41 immediately after the completion of video 41 distributed from server 10. As an example of the effect of such a configuration, user B can look back video 41 at any time.

### Eighth Embodiment

In the fifth embodiment to the seventh embodiment, thumbnail 56 may indicate a feature portion of digest video 54. In the eighth embodiment, control section 11 of server 10 automatically creates thumbnail 56 that visualizes a feature portion of digest video 54. Note that the same configurations as those of the first embodiment to the seventh embodiment are denoted with the same reference numerals, and the overlapping description is omitted. The details of the eighth embodiment are applicable to any of other embodiments.

For example, as in the fifth embodiment, control section 11 of server 10 creates a digest video for playing the part corresponding to first input T1 of user B on the basis of the gift information sent from terminal 20B (B51). Then, control section 11 of server 10 may detect a feature portion of digest video 54 on the basis of the information about digest video 54, and create thumbnail 56 that visualizes that feature portion.

More specifically, by way of example but not limitation, control section 11 of server 10 may or may not detect a feature portion of digest video 54 on the basis of at least one of the amount of the comment of the user for the distributor of video 41 (such as the amount of comment and the number of letters), the distributor's voice (such as the volume), the distributor's facial expression (such as the size of the mouth or eyes, and the number of movements), and the level of gift 42 (e.g., the amount of charging and the like).

For example, control section 11 of server 10 may calculate the sound volume of the distributor in digest video 54. Then, control section 11 of server 10 may detect as a feature portion of digest video 54 the portion where the sound volume of the distributor is largest. In addition, control section 11 of server 10 may analyze the distributor's facial expression in digest video 54. Then, control section 11 of server 10 may detect as a feature portion of digest video 54 the portion where the size and/or the number of movements of the distributor's mouth is largest, for example.

In addition, control section 11 of server 10 may calculate the level of gift 42, i.e., the amount of charging of gift 42, sent by user B in digest video 54. Then, control section 11 of server 10 may detect as a feature portion of digest video 54 the portion where the gifting of gift 42 with the largest of charging amount is performed among gifts 42 sent by user B, for example. In addition, control section 11 of server 10 may calculate the amount of comment from the user in digest video 54. Then, control section 11 of server 10 may detect as a feature portion of digest video 54 the portion where the amount of comment is largest, for example.

In this manner, when detecting a feature portion of digest video 54, control section 11 of server 10 may create thumbnail 56 that visualizes that feature portion. Then, control section 11 of server 10 transmits to terminal 20B the created thumbnail 56 together with the feature of digest video 54 (B52). In this manner, display section 24 of terminal 20B displays thumbnail 56 including the feature portion where gifting of gift 42 is performed in digest video 41 as illustrated in FIG. 27, for example.

### Effects of Eighth Embodiment

In the eighth embodiment, control section 11 of server 10 automatically creates thumbnail 56 on the basis of a feature portion of digest video 54. As an example of the effect of such a configuration, user B can easily determine the content of digest video 54.

In addition, in the eighth embodiment, thumbnail 56 may be created on the basis of at least one of the amount of the comment of the user for the distributor of video 41, the distributor's voice, the distributor's facial expression, and the level of gift 42. As an example of the effect of such a configuration, user B can more easily determine the content of digest video 54.

### Eighth Modification (1)

In the eighth embodiment, thumbnail 56 is created by control section 11 of server 10, but it may be created by control section 21 of terminal 20B. The eighth modification (1) is a modification in which control section 21 of terminal 20B automatically creates thumbnail 56 that visualizes a feature portion of digest video 54.

For example, as in the fifth embodiment, when a feature of digest video 54 sent from the server is received by communication section 22 (C51), control section 21 of terminal 20B stores the information about digest video 54 in storage section 28. Here, control section 21 of terminal 20B may detect a feature portion of digest video 54 on the basis of the information about digest video 54, and create thumbnail 56 that visualizes that feature portion. For example, as illustrated in FIG. 27, control section 21 of terminal 20B creates thumbnail 56 including the feature portion where gifting of gift 42 is performed in digest video 41, and controls display section 24 to display that thumbnail 56.

### Effects of Eighth Modification (1)

In eighth modification (1), control section 21 of terminal 20B automatically creates thumbnail 56 on the basis of a feature portion of digest video 54. As an example of the effect of such a configuration, the data throughput of server 10 can be suppressed because terminal 20B creates thumbnail 56.

### Eighth Modification (2)

In the eighth embodiment, thumbnail 56 is automatically created by server 10 or terminal 20B, but this is not limitative as long as it can be created on the basis of a feature portion of digest video 54. Eighth modification (2) is a modification in which user B creates thumbnail 56 by manually selecting a feature portion of digest video 54.

For example, as in the fifth embodiment, when a feature of digest video 54 sent from the server is received by communication section 22 (C51), control section 21 of terminal 20B stores the information about digest video 54 in storage section 28. Here, control section 21 of terminal 20B may cause user B to select a feature portion of digest video 54 to create thumbnail 56. For example, control section 21 of terminal 20B may or may not play digest video 54 so as to cause user B to select the desired feature portion from that digest video 54. In this manner, control section 21 of terminal 20B creates thumbnail 56 on the basis of the feature portion selected by user B.

### Effects of Eighth Modification (2)

In eighth modification (2), control section 21 of terminal 20B creates thumbnail 56 on the basis of a feature portion of digest video 54 selected by user B. As an example of the effect of such a configuration, user B can display the desired feature portion in thumbnail 56.

### Ninth Embodiment

In the fifth embodiment to the eighth embodiment, control section 21 of terminal 20B may display the information related to the content of digest video 54 on play button 55 for playing digest video 54. Note that the same configurations as those of the first embodiment to the eighth embodiment are denoted with the same reference numerals, and the overlapping description is omitted. The details of the ninth embodiment are applicable to any of other embodiments.

For example, as in the fifth embodiment, when the information about digest video 54 sent from server 10 is received by communication section 22 (C51), control section 21 of terminal 20B displays play button 55 for playing digest video 54 on display section 24 on the basis of that information. At this time, as illustrated in FIG. 35, control section 21 of terminal 20B may display on play button 55 content information 60 representing the content of digest video 54 on the basis of the information about digest video 54.

Here, by way of example but not limitation, content information 60 may or may not include the time periods “3:15 to 3:30” and “5:00 to 5:30” that represent extraction portions of digest video 54 from video 41. In addition, content information 60 may or may not include the contents “1,000 yen social tipping” and “gift item sent” of gift 42 sent in digest video 54.

Then, control section 21 of terminal 20B controls display section 24 to play digest video 54 on the basis of the input of user B on play button 55 (C52).

### Effects of Ninth Embodiment

In the ninth embodiment, play button 55 (which is, by way of example but not limitation, an example of the second information) includes content information 60 related to the content of digest video 54 (which is, by way of example but not limitation, an example of the information related to the content of digest video 54). As an example of the effect of such a configuration, user B can easily determine the content of digest video 54.

### Tenth Embodiment

In the fifth embodiment to the ninth embodiment, in digest video 54, gift 42 sent from other users different from user B may be removed. Note that the same configurations as those of the first embodiment to the ninth embodiment are denoted with the same reference numerals, and the overlapping description is omitted. The details of the tenth embodiment are applicable to any of other embodiments.

For example, as in the fifth embodiment, control section 11 of server 10 creates digest video 54 for playing the parts corresponding first inputs T1 and T2 of user B on the basis of the gift information sent from terminal 20B (B51). At this time, in some situation digest video 54 can include gifts from users of other terminals 20 different from terminal 20B.

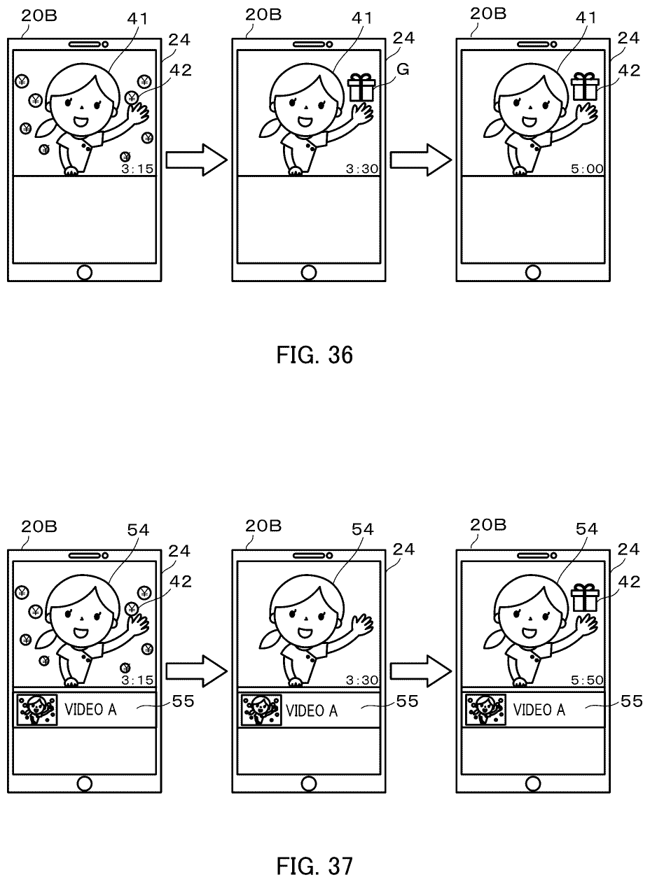

For example, it is assumed that as illustrated in FIG. 36, user B has performed first input T1 for gifting of social tipping gift 42 at the time “3:15”, and performed first input T2 for gifting of gift 42 of a gift item at the time “5:00”. Here, it is assumed that a user of another terminal 20 has performed gifting of gift G of a gift item by performing a fourth input on display section 24 of another terminal 20 displaying video 41 at the time “3:30”. In this case, if control section 11 of server 10 performs extraction between the time “3:15” of first input T1 and the time “5:00” of first input T2 in video 41, then digest video 54 may include gift G of another user and its effect, and the like.

In view of this, in the case where gift G of another user is included in digest video 54, control section 11 of server 10 may remove gift G of another user from digest video 54. For example, control section 11 of server 10 may or may not create digest video 54 by performing a process of removing gift G from the frame of the time “3:30” where gift G of another user is included.

In addition, in the case where gift G of another user is displayed in a superimposed manner on video 41, control section 11 of server 10 may or may not create digest video 54 by performing a process of removing only the superimposed display of gift G while retaining the superimposed display of gift 42. In addition, control section 11 of server 10 may or may not create digest video 54 by performing a process of thinning out the frame of the time “3:30” where gift G of another user is included.

In this manner, digest video 54 from which gift G based on the fourth input of another user is removed is created. Control section 11 of server 10 transmits information about the created digest video 54 to terminal 20B (B52). When the information about digest video 54 sent from server 10 is received by communication section 22 (C51), control section 21 of terminal 20B displays play button 55 for playing digest video 54 on display section 24 as illustrated in FIG. 37.

Then, control section 21 of terminal 20B controls display section 24 to play digest video 54 on the basis of an input operation on play button 55 (C52). At this time, display section 24 displays the scene where gifting of gift 42 is performed by user B at the time “3:15”, and thereafter displays the scene with only the distributor where gift G of another user is removed at the time “3:30”. Subsequently, display section 24 displays the scene where gifting of gift 42 is performed by user B at the time “5:00”. As described above, digest video 54 where gift G other than gift 42 of user B is removed is played on display section 24.

### Effects of Tenth Embodiment

In the tenth embodiment, video 41 includes gift G (which is, by way of example but not limitation, an example of the image information) based on the fourth input on display section 24 of another terminal 20 displaying video 41 by the user of other terminal 20 different from terminal 20B. Then, gift G is removed in digest video 54 (which is, by way of example but not limitation, an example of the first video). As an example of the effect of such a configuration, user B can view digest video 54 including only the scene where gifting of gift 42 is performed by user B.

### Eleventh Embodiment

In the first embodiment to the tenth embodiment, in the case where video 41 or digest video 54 is played on display section 24 of terminal 20B, the content of gift 42 sent by user B may be displayed. Note that the same configurations as those of the first embodiment to the tenth embodiment are denoted with the same reference numerals, and the overlapping description is omitted. The details of the eleventh embodiment are applicable to any of other embodiments.

For example, control section 11 of server 10 creates digest video 54 for playing the parts corresponding first inputs T1 and T2 of user B on the basis of the gift information sent from terminal 20B (B51). Here, control section 11 of server 10 may create content information for displaying the content of gift 42 sent by user B in a scene of digest video 54 corresponding to first inputs T1 and T2.

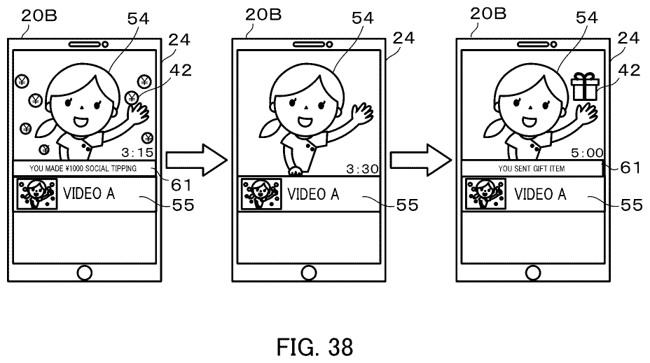

Control section 11 of server 10 transmits to terminal 20B the created content information together with digest video 54 (B52). When the information about digest video 54 sent from server 10 is received by communication section 22 (C51), control section 21 of terminal 20B displays play button 55 for playing digest video 54 on display section 24 as illustrated in FIG. 38.

Then, control section 21 of terminal 20B controls display section 24 to play digest video 54 on the basis of an input operation on play button 55 (C52). At this time, control section 21 of terminal 20B displays on display section 24 content information 61 about gift 42 such as “you made 1,000 yen social tipping” in the scene of the time “3:15” where user B has performed first input T1. Subsequently, control section 21 of terminal 20B does not displays on display section 24 content information 61 about gift 42 in the scene of the time “3:30” where user B has not performed the first input, but displays on display section 24 content information 61 about gift 42 such as “you performed gifting of gift item” in the scene of the time “5:00” where user B has performed first input T2.

### Effects of Eleventh Embodiment

In the eleventh embodiment, the second information related to video 41 includes content information 61 (which is, by way of example but not limitation, an example of information related to the content of first inputs T1 and T2) related to the content of first inputs T1 and T2. As an example of the effect of such a configuration, user B can easily determine the content of gift 42 sent by user B.

### Twelfth Embodiment

In the first embodiment to the eleventh embodiment, the distributor of video 41 may transmit content to user B of terminal 20B who received from server 10 a time stamp or digest video 54 related to video 41 of the distributor. Note that the same configurations as those of the first embodiment to the eleventh embodiment are denoted with the same reference numerals, and the overlapping description is omitted. The details of the twelfth embodiment are applicable to any of other embodiments.

### Information Processing

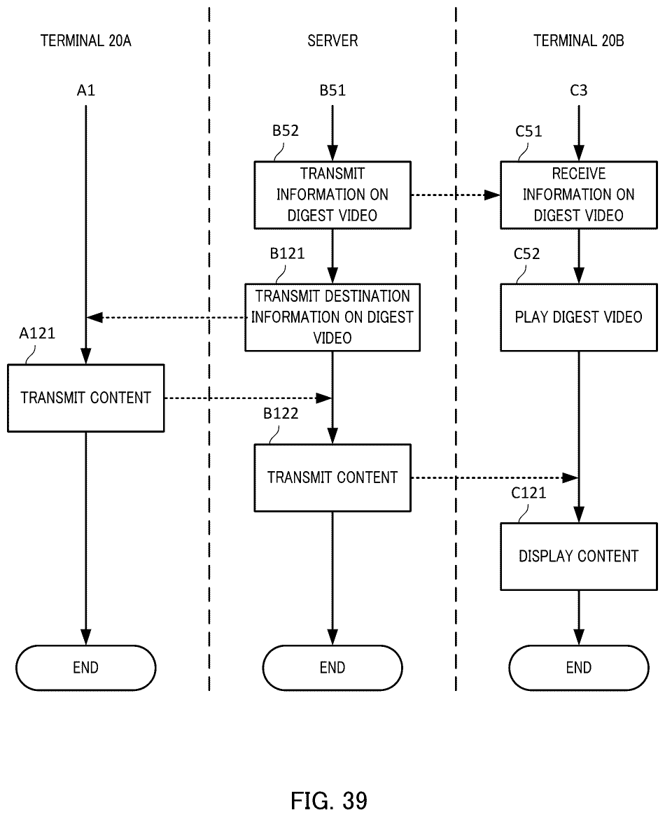

FIG. 39 is a flowchart illustrating an example of a procedure of processes executed by each apparatus in the present embodiment.

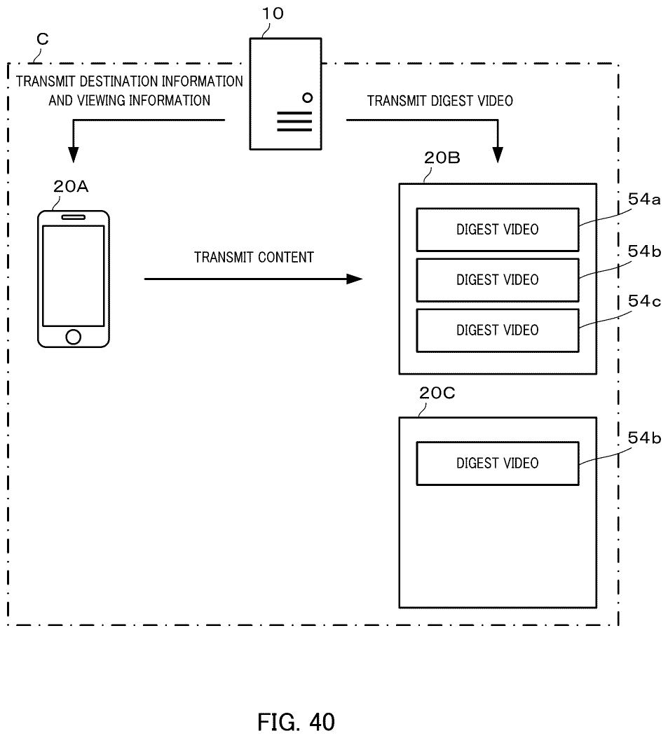

For example, as in the fifth embodiment, when digest video 54 is created on the basis of the gift information sent from terminal 20B (B51), control section 11 of server 10 transmits the information about digest video 54 to terminal 20B (B52). Here, it is assumed that as illustrated in FIG. 40, server 10 has formed predetermined community C for distributing video 41 from terminal 20A to terminals 20B and 20C, and has transmitted digest video 54a to terminal 20B included in community C.

When receiving digest video 54 sent from server 10 a (C51), control section 21 of terminal 20B controls display section 24 to play digest video 54a in accordance with the operation of user B (C52). On the other hand, when information about digest video 54a is transmitted to terminal 20B (B52), control section 11 of server 10 may transmit destination information of digest video 54a to terminal 20A of the distributor of video 41 (B121).

Note that the destination information is information for sending content to terminals 20B and 20C where digest video 54 has been transmitted, and may include contact information such as mail addresses and addresses of SNS service, for example. In addition, the content needs only to be in a form that can transmit information such as messages, and may be composed of letter information, image information, voice information and the like, for example.

Here, control section 11 of server 10 may determine whether distributor's terminal 20A and terminal 20B that is the destination of digest video 54a are included in predetermined community C, and transmit the destination information to terminal 20A in the case where they are included in predetermined community C. Note that predetermined community C may have a relationship that limits transmission of content from terminal 20B to terminal 20A while allowing for transmission of content from distributor's terminal 20A to terminal 20B, for example.

In addition, control section 11 of server 10 may transmit to terminal 20A viewing information related to viewing of video 41 of the distributor by user B. Here, the viewing information may or may not include the number of digest videos 54a to 54c transmitted from server 10 to terminal 20B, i.e., the number of digest videos 54a to 54c acquired by terminal 20B. For example, in the case where terminal 20B has acquired three digest videos 54a to 54c, control section 11 of server 10 may transmit to terminal 20A the viewing information including the number of videos. In addition, control section 11 of server 10 may transmit to terminal 20A viewing information further including the number of digest videos 54b acquired by terminal 20C.

In addition, the viewing information may or may not include the amount of increase in the number of digest videos 54a to 54c acquired by terminal 20B. For example, control section 11 of server 10 may calculate the rate of increase in the number of digest videos 54a to 54c acquired by terminal 20B, and transmit to terminal 20A viewing information including the rate of increase. In addition, the viewing information may include list information about digest videos 54a to 54c acquired by terminal 20B. For example, control section 11 of server 10 may list the information about digest videos 54a to 54c acquired by terminal 20B, and transmit to terminal 20A viewing information including that list information.

In addition, the viewing information may or may not include a comment sent by user B of terminal 20B to video 41 of the distributor. For example, in the case where a comment for appealing the user to the distributor, such as “I cut back on my food budget for a week for this gift 42!”, is sent to video 41, control section 11 of server 10 may transmit to terminal 20A that comment as viewing information.

When receiving destination information and viewing information sent from server 10, control section 21 of terminal 20A controls display section 24 to display the viewing information. Then, the distributor confirms the viewing information and determines whether to send the content to user B. At this time, the distributor may compare the number, the amount of increase, list information and the like of digest videos 54 acquired by terminals 20B and 20C, to determine whether to send the content to user B, for example. Then, when an operation of sending a content is performed by the distributor, control section 21 of terminal 20A transmits to server 10 the content destined to user B on the basis of the destination information (A121). For example, the distributor may transmit a content including a thank-you message for the acquisition of digest video 54, distribution schedule of video 41 and the like. When receiving a content sent from terminal 20A, control section 11 of server 10 transmits that content to terminal 20B (B122). Then, when receiving the content sent from server 10, control section 11 of terminal 20B controls display section 24 to display that content (C121).

### Effects of Twelfth Embodiment

In the twelfth embodiment, in the case where digest video 54 is transmitted to terminal 20B, control section 11 of server 10 transmits its destination information to terminal 20A of the distributor of video 41. As an example of the effect of such a configuration, the emotional distance between the distributor and the viewer user B can be reduced because a content can be sent from the distributor of video 41 to terminal 20B of user B.

In addition, in the twelfth embodiment, control section 11 of server 10 may transmit to terminal 20A viewing information of video 41 by user B. As an example of the effect of such a configuration, the distributor can determine user B who has high interest in video 41 of the distributor, and thus can send an appropriate content to user B.

### Other Notes

Although embodiments of the present disclosure have been described based on the drawings and examples, it should be noted that one skilled in the art can easily make various changes and modifications based on the present disclosure. Accordingly, it should be noted that these variations and modifications are included in the scope of the present disclosure. As an example rather than a limitation, the functions, etc. included in each means, each step, etc. can be rearranged so as not to be logically inconsistent, and a plurality of means and steps, etc. can be combined or divided into one. It is also possible to combine the configurations shown in each embodiment as appropriate.

### REFERENCE SIGNS LIST

1 System
10 Server
20 Terminal
30 Network

1. An information processing method of a terminal configured to display a video distributed from a server, the method comprising:
receiving, by a communication section of the terminal, the video distributed from the server;
displaying on a display section of the terminal the video that is distributed;
acquiring, by a control section of the terminal, first information based on a first input performed by a user of the terminal on the display section displaying the video;
acquiring, by the control section, second information related to the video based on the first information;
displaying the second information on the display section; and
performing, by the control section, a control of playing on the display section a part corresponding to the first input in the video, based on an input for the second information performed by the user of the terminal.

2. The information processing method according to claim 1, wherein the first information includes gift information of a user for the video.

3. The information processing method according to claim 1, wherein the second information includes information representing a play position corresponding to the first input in the video.

4. The information processing method according to claim 3, wherein the information representing the play position includes information related to a time or a time period.

5. The information processing method according to claim 3, wherein the information representing the play position includes information representing a play position on a seek bar of the video.

6. The information processing method according to claim 1,
wherein the first input includes a plurality of inputs; and
wherein the method further comprises performing, by the control section, a control of playing on the display section a part corresponding to each first input in the video, based on an input for the second information by the user of the terminal.

7. The information processing method according to claim 3, wherein the second information includes data related to a reaction of a user to the video.

8. The information processing method according to claim 3, further comprising:
acquiring, by the control section, third information including information representing a play position of the video, the third information corresponding to a third input on a display section of the first terminal displaying the video by a user of a first terminal different from the terminal; and
displaying the third information on the display section of the terminal.

9. The information processing method according to claim 1,
wherein the second information includes information about a first video obtained by extracting at least a part of the video, based on the first input, and
wherein the method further comprises performing, by the control section, a control of playing the first video on the display section, based on an input for the second information by the user of the terminal.

10. The information processing method according to claim 9,
wherein the first input includes a plurality of inputs, and
wherein the first video is formed based on a part corresponding to each first input in the video.

11. The information processing method according to claim 9, further comprising performing, by the control section, a control of switching the video played on the display section from the first video to the video distributed from the server based on an input of the user of the terminal.

12. The information processing method according to claim 9, wherein a start point of the first video is set based on a time point when the first input is performed.

13. The information processing method according to claim 12, wherein an end point of the first video is set based on at least one of an amount of a comment of a user to a distributor of the video distributed from the server, a voice of the distributor, and a facial expression of the distributor.

14. The information processing method according to claim 13, wherein the first video is set by thinning out a predetermined part between a start point of the first video and an end point of the first video.

15. The information processing method according to claim 9, wherein the second information includes information about a thumbnail corresponding to the first video.

16. The information processing method according to claim 9, wherein the second information includes information related to a content of the first video.

17. The information processing method according to claim 9,
wherein the video includes image information based on a fourth input performed on a display section of the first terminal displaying the video by a user of a first terminal different from the terminal, and
wherein in the first video, the image information is removed.

18. The information processing method according to claim 1, wherein the second information includes information related to a content of the first input.

19. A terminal configured to display a video distributed from a server, the terminal comprising:
a communication section configured to receive the video distributed from the server;
a display section configured to display the video that is distributed; and
a control section configured to display second information on the display section by acquiring first information based on a first input performed by a user of the terminal on the display section displaying the video, and then acquiring the second information related to the video based on the first information, wherein
the control section performs a control of playing on the display section a part corresponding to the first input in the video, based on an input for the second information performed by the user of the terminal.

20. A server configured to communicate with a terminal configured to display a distributed video, the server comprising:
a communication section configured to distribute the video to the terminal, and receive first information from the terminal, the first information being information based on a first input performed by a user of the terminal on a display section of the terminal displaying the video; and
a control section configured to perform a control of transmitting, by the communication section, second information related to the video to the terminal, based on the first information,
wherein the second information includes information of playing on the display section a part corresponding to the first input in the video, based on an input performed by the user of the terminal for the second information displayed on the display section.
